(19) United States
(12) Patent Application Publication
(10) Pub. No.: US 2025/0254614 A1
(43) Pub. Date: Aug. 7, 2025

(54) METHOD AND APPARATUS FOR ENERGY SAVING IN WIRELESS COMMUNICATION SYSTEM

(71) Applicant: SAMSUNG ELECTRONICS CO., LTD., Suwon-si (KR)

(72) Inventors: Junyung YI, Suwon-si (KR); Younsun KIM, Suwon-si (KR); Hyunsuk RYU, Suwon-si (KR); Seunghoon CHOI, Suwon-si (KR)

(21) Appl. No.: 19/044,420

(22) Filed: Feb. 3, 2025

(30) Foreign Application Priority Data
Feb. 5, 2024 (KR) 10-2024-0017658

(51) Int. Cl. H04W 52/02; H04W 48/14; H04W 72/23

(52) U.S. Cl. CPC H04W 52/0206; H04W 48/14; H04W 72/23

(57) ABSTRACT

The disclosure relates to a 5G or 6G communication system for supporting a higher data transmission rate. A method performed by a user equipment (UE) in a wireless communication system comprises receiving, from of a base station (BS) on a primary cell, configuration information for on-demand synchronization signal block (SSB) of a secondary cell, receiving, from the BS on the primary cell, a downlink signal, identifying an activation of the on-demand SSB of the secondary cell based on the configuration signal and the downlink signal, and receiving the on-demand SSB on the secondary cell.

### CROSS-REFERENCE TO RELATED APPLICATION

This application is based on and claims priority under 35 U.S.C. § 119 to Korean Patent Application No. 10-2024-0017658 filed on Feb. 5, 2024, in the Korean Intellectual Property Office, the disclosure of which is/are incorporated by reference herein in its/their entirety.

### BACKGROUND

### 1. Field

The disclosure relates to operation of a user equipment and base station in a wireless communication system. Specifically, the disclosure related to a method and apparatus for energy saving in a wireless communication system.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Recently, in line with development of 5G/6G communication systems that consider environments, there is a need for a method for reducing energy consumed by communication systems (for example, UEs, gNBs, networks, and the like), or a method for energy saving.

The above information is presented as background information only to assist with an understanding of the disclosure. No determination has been made, and no assertion is made, as to whether any of the above might be applicable as prior art with regard to the disclosure.

### SUMMARY

According to various embodiments of the disclosure, a gNB in a wireless communication system may perform on-demand operations with regard to a secondary cell (SCell) during a UE-related carrier aggregation (CA) operation in order to reduce energy consumption. The gNB may configure a secondary cell group, SCell activation/deactivation, and/or on-demand operations through higher layer signaling and/or L1 signaling for on-demand operations in the SCell. A method for operating the UE according to respective configurations may be provided.

Various embodiments of the disclosure may provide a configuration method through higher layer signaling (for example, RRC signaling) for applying on-demand operations, and may provide a method for SCell activation and deactivation and on-demand operation activation and deactivation through higher layer signaling and/or L1 signaling. In addition, an on-demand SSB activation time may be defined according to the configurations, and the UE may define operations according to the configurations.

The technical subjects pursued in the disclosure may not be limited to the above mentioned technical subjects, and other technical subjects which are not mentioned may be clearly understood from the following descriptions by those skilled in the art to which the disclosure pertains.

The method according to an embodiment relates to processing a control signal in a wireless communication system, the method including: receiving a first control signal transmitted from a base station; processing the received first control signal; generating a second signal, based on the processing; and transmitting the generated second control signal to the base station.

An embodiment of the disclosure is advantageous in that, through on-demand operations of a gNB in a 5G mobile communication system, signals and channels that are always transmitted periodically (for example, synchronization signal (SS) block (SSB), physical broadcast channel (PBCH), or system information block type 1 (SIB1)) are transmitted only in a necessary case, thereby reducing unnecessary energy consumption by the gNB.

In addition, UE operations during the gNB's on-demand operations for the gNB's energy saving may be provided.

Advantageous effects obtainable from the disclosure may not be limited to the above-mentioned effects, and other effects which are not mentioned may be clearly understood from the following descriptions by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a time-frequency domain as a radio resource region in a wireless communication system according to an embodiment of the disclosure;

FIG. 2 illustrates an example of a slot structure in a wireless communication system according to an embodiment of the disclosure;

FIG. 3 illustrates an example of a beam sweeping operation and a time domain mapping structure of a synchronization signal according to an embodiment of the disclosure;

FIG. 4 illustrates an example of a synchronization signal block considered in a wireless communication system according to an embodiment of the disclosure;

FIG. 5 illustrates examples of various transmission of a synchronization signal block in a frequency band below 6 GHz considered in a wireless communication system according to an embodiment of the disclosure;

FIG. 6 illustrates examples of transmission of a synchronization signal block in a frequency band of 6 GHz or higher considered in a wireless communication system according to an embodiment of the disclosure;

FIG. 7 illustrates examples of transmission of a synchronization signal block according to a subcarrier spacing within a time of 5 ms in a wireless communication system according to an embodiment of the disclosure;

FIG. 8 illustrates an example of DMRS patterns (type 1 and type 2) used for communication between a gNB and a UE in a wireless communication system according to an embodiment of the disclosure;

FIG. 9 illustrates an example of channel estimation using a DMRS received in one PUSCH in the time domain of a wireless communication system according to an embodiment of the disclosure;

FIG. 10 illustrates a method for reconfiguring SSB transmission through dynamic signaling of a wireless communication system according to an embodiment of the disclosure;

FIG. 11 illustrates a method for reconfiguring a BWP and a BW through dynamic signaling of a wireless communication system according to an embodiment of the disclosure;

FIG. 12 illustrates a method for reconfiguring DRX through dynamic signaling of a wireless communication system according to an embodiment of the disclosure;

FIG. 13 illustrates a DTx method for gNB energy saving according to an embodiment of the disclosure;

FIG. 14 illustrates an example of operations of a gNB according to a gNB wakeup signal according to an embodiment of the disclosure;

FIG. 15 illustrates an example of a gNB's antenna adaptation method for energy saving of a wireless communication system according to an embodiment of the disclosure;

FIG. 16 illustrates an example of on-demand SSB operations of a gNB and a UE according to an embodiment of the disclosure;

FIG. 17 illustrates an example of a method for configuring SCell activation/deactivation and on-demand SSB by a gNB according to an embodiment of the disclosure;

FIG. 18 illustrates an example of a method for configuring SCell activation/deactivation and on-demand SSB, based on a MAC-CE, by a gNB according to an embodiment of the disclosure;

FIG. 19 illustrates examples of operations of a gNB and a UE according to an on-demand SSB SCell for the gNB's energy saving according to an embodiment of the disclosure;

FIG. 20 illustrates an example of an on-demand SSB activation time for energy saving of a wireless communication system according to an embodiment of the disclosure;

FIG. 21 illustrates an example of an on-demand SSB activation time for energy saving of a wireless communication system according to an embodiment of the disclosure;

FIG. 22 illustrates an example of an on-demand SSB activation time for energy saving of a wireless communication system according to an embodiment of the disclosure;

FIG. 23 illustrates an example of an on-demand SSB activation time for energy saving of a wireless communication system according to an embodiment of the disclosure;

FIG. 24 illustrates a flowchart of a UE to which a wireless communication system's energy saving method according to an embodiment of the disclosure is applied;

FIG. 25 illustrates a flowchart of a gNB to which a wireless communication system's energy saving method according to an embodiment of the disclosure is applied;

FIG. 26 illustrates an example of a UE according to an embodiment of the disclosure; and

FIG. 27 illustrates an example of a base station according to an embodiment of the disclosure.

### DETAILED DESCRIPTION

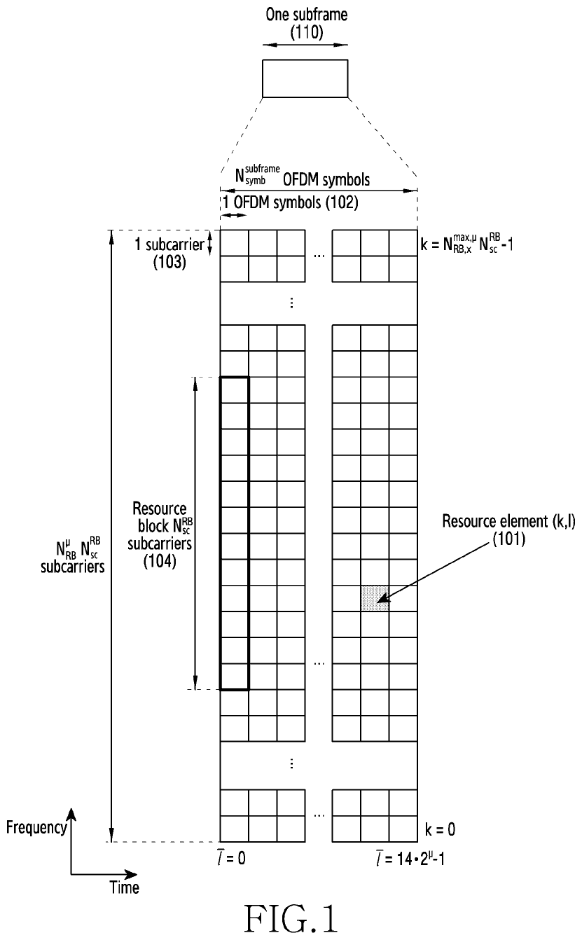

FIGS. 1 through 27, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing embodiments of the disclosure below, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station.

Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in embodiments may include one or more processors.

Method and devices as provided in the embodiments of the disclosure below may be applied without being limited to the respective embodiments, and all or some of one or more embodiments provided in the disclosure may be employed in combination. Therefore, based on determinations by those skilled in the art, the embodiments of the disclosure may be applied through some modifications without significantly departing from the scope of the disclosure.

A wireless communication system is advancing to a broadband wireless communication system for providing high-speed and high-quality packet data services using communication standards, such as high-speed packet access (HSPA) of 3GPP, LTE-Advanced (LTE-A), LTE-Pro, high-rate packet data (HRPD) of 3GPP2, ultra-mobile broadband (UMB), IEEE 802.17e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC requires wider coverage than those of other services provided by the 5G communication system because the UEs are likely to be located in a shadow area, such as a basement of a building, which is not covered by the cell due to the nature of the service. The UE supporting mMTC must be configured to be inexpensive, and requires a very long battery lifetime such as 10 to 15 years because it is difficult to frequently replace the battery of the UE.

Lastly, URLLC is a cellular-based mission-critical wireless communication service. For example, URLLC may be considered as services used for remote control for robots or machinery, industrial automation, unmanned aerial vehicles, remote health care, or emergency alert. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and must also assign a large number of resources in a frequency band in order to secure reliability of a communication link.

The three services in the 5G communication system (hereinafter may be interchangeably used with “5G system”), that is, eMBB, URLLC, and mMTC, may be multiplexed and transmitted in a single system. In this case, different transmission/reception techniques and transmission/reception parameters may be used between services in order to satisfy different requirements of the respective services.

Hereinafter, a time-frequency domain resource and a frame structure of a 5G system will be described in more detail with reference to the accompanying drawings. Hereinafter, a configuration of a 5G system will be described as an example of a wireless communication to which the disclosure is applied for the sake of descriptive convenience, but the embodiments of the disclosure may also be applied in the same or similar manner to 5G or higher systems or other communication systems to which the disclosure is applicable.

FIG. 1 illustrates an example of a time-frequency domain as a radio resource region in a wireless communication system according to an embodiment of the disclosure.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol (or discrete Fourier transform spread OFDM (DFT-s-OFDM) symbol) 102 on the time axis and one subcarrier 103 on the frequency axis. In the frequency domain, N_{SC}^{RB} (for example, 12) consecutive REs representing the number of subcarriers per resource block (RB) may constitute one resource block (RB) 104. Also, in the time domain, Nₛₗₒₜ^{subframe,μ} consecutive OFDM symbols representing the number of symbols per subframe according to subcarrier spacing configuration values u may constitute one subframe 110.

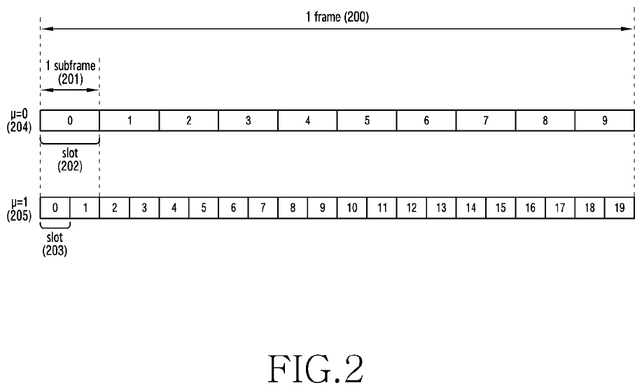

FIG. 2 illustrates an example of a slot structure in a wireless communication system according to an embodiment of the disclosure.

In FIG. 2, an example of a slot structure including a frame 200, a subframe 201, and a slot 202 or 203 is illustrated. One frame 200 may be defined as 10 ms. One subframe 201 may be defined as 1 ms, and thus one frame 200 may include a total of ten subframes 201. One slot 202 or 203 may be defined as 14 OFDM symbols (i.e., the number of symbols per one slot is N_{symb}^{slot}=14).

One subframe 201 may include one or multiple slots 202 and 203, and the number of slots 202 and 203 per one subframe 201 may vary depending on configuration values u for the subcarrier spacing 204 or 205.

FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots (for example, slots 203). That is, the number of slots per one subframe Nₛₗₒₜ^{subframe,μ} slot may differ depending on the subcarrier spacing configuration value μ, and the number of slots per one frame Nₛₗₒₜ^{frame,μ} slot may differ accordingly. For example, Nₛₗₒₜ^{subframe,μ} and Nₛₗₒₜ^{frame,μ} slot may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the 5G wireless communication system, a synchronization signal block (SSB) (SS block or SS/PBCH block may be interchangeably used) for initial access of a UE may be transmitted, and the synchronization signal block may include a primary synchronization signal (PSS), a secondary synchronization signal (SSS), and a physical broadcast channel (PBCH).

During an initial access operation of a UE accessing a system, the UE may first acquire downlink time and frequency domain synchronization from a synchronization signal via a cell search and may acquire a cell ID. The synchronization signal may include a PSS and an SSS. In addition, the UE may receive, from a base station, a PBCH for transmitting of a master information block (MIB) so as to acquire a basic parameter value and system information related to transmission and reception, such as a system bandwidth or related control information. Based on this information, the UE may perform decoding on a physical downlink control channel (PDCCH) and a physical downlink shared channel (PDSCH) so as to acquire a system information block (SIB). Then, the UE may exchange UE identification-related information with the base station via a random-access operation, and may initially access a network via registration and authentication operations. Additionally, the UE may receive system information (system information block (SIB)) transmitted by the base station to acquire cell-common transmission and reception-related control information. The cell-common transmission and reception-related control information may include random-access-related control information, paging-related control information, common control information for various physical channels, etc.

A synchronization signal is a signal that serves as a reference for a cell search, and for each frequency band, a subcarrier spacing may be applied adaptively to a channel environment, such as phase noise. For a data channel or a control channel, in order to support various services as described above, a subcarrier spacing may be applied differently depending on a service type.

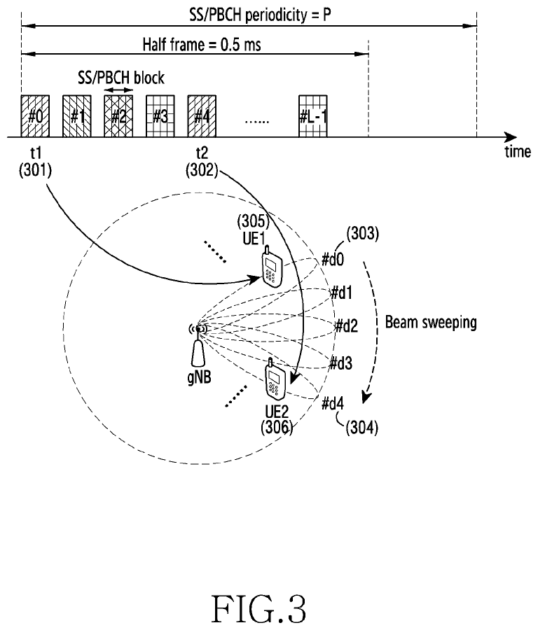

FIG. 3 illustrates an example of a beam sweeping operation and a time domain mapping structure of a synchronization signal according to an embodiment of the disclosure.

For description purposes, the following elements may be defined.

Primary synchronization signal (PSS): A PSS is a signal that serves as a reference for DL time/frequency synchronization, and provides a part of cell ID information.

Secondary synchronization signal (SSS): An SSS serves as a reference for DL time/frequency synchronization, and provides the other part of the cell ID information. Additionally, the SSS may serve as a reference signal for PBCH demodulation of a PBCH.

Physical broadcast channel (PBCH): A PBCH provides a master information block (MIB) which is essential system information required for transmission and reception of a data channel and a control channel of a UE. The mandatory system information may include search space-related control information indicating radio resource mapping information of a control channel, scheduling control information for a separate data channel for transmission of system information, a system frame number (SFN) which is a frame unit index that serves as a timing reference, and other information.

Synchronization signal/PBCH block (SS/PBCH block) or SSB: An SS/PBCH block is configured by N OFDM symbols and may include a combination of a PSS, an SSS, a PBCH, etc. For a system to which a beam sweeping technology is applied, an SS/PBCH block is a minimum unit to which beam sweeping is applied. In the 5G system, N=4 may be satisfied. A base station may transmit up to a maximum of L SS/PBCH blocks, and the L SS/PBCH blocks are mapped within a half frame (0.5 ms). In addition, the L SS/PBCH blocks are periodically repeated at predetermined periods P. The base station may inform a user equipment of period P via signaling. If there is no separate signaling of period P, the UE may apply a previously agreed default value.

Referring to FIG. 3, FIG. 3 illustrates an example in which beam sweeping is applied in units of SS/PBCH blocks over time. UE 1 205 receives an SS/PBCH block by means of a beam emitted in direction #d0 303 by beamforming applied to SS/PBCH block #0 at time point t1 301. In addition, UE 2 306 receives an SS/PBCH block by means of a beam emitted in direction #d4 302 by beamforming applied to SS/PBCH block #4 at time point t2 304. The UE may acquire, from the base station, an optimal synchronization signal via a beam emitted in the direction where the UE is located. For example, it may be difficult for UE 1 305 to acquire time/frequency synchronization and mandatory system information from the SS/PBCH block through the beam emitted in direction #d4 far away from the location of UE 1.

In addition to the initial access procedure, for the purpose of determining whether the radio link quality of a current cell is maintained at a certain level or higher, the UE may also receive the SS/PBCH block. Furthermore, during a handover procedure in which the UE moves access from the current cell to an adjacent cell, the UE may receive an SS/PBCH block of the adjacent cell in order to determine the radio link quality of the adjacent cell and acquire time/frequency synchronization with the adjacent cell.

Hereinafter, initial cell access operations of the 5G wireless communication system will be described in more detail with reference to drawings.

A synchronization signal is a signal that serves as a reference for a cell search, and may be transmitted by applying of a subcarrier spacing appropriate for a channel environment (e.g., phase noise) for each frequency band. A 5G base station may transmit multiple synchronization signal blocks according to the number of analog beams to be operated. For example, a PSS and an SSS may be mapped and transmitted over 12 RBs, and a PBCH may be mapped and transmitted over 24 RBs. Hereinafter, a description will be provided for a structure in which a synchronization signal and a PBCH are transmitted in the 5G communication system.

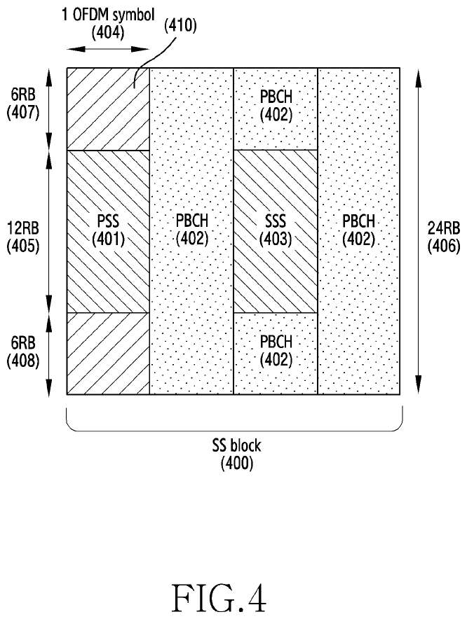

FIG. 4 illustrates an example of a synchronization signal block considered in a wireless communication system according to an embodiment of the disclosure.

According to FIG. 4, a synchronization signal block (SS block) 400 may include a PSS 401, an SSS 403, and a physical broadcast channel (PBCH) 402.

The synchronization signal block 400 may be mapped to four OFDM symbols 404 on the time axis. The PSS 401 and the SSS 403 may be transmitted in 12 RBs 405 on the frequency axis, and in first and third OFDM symbols, respectively, on the time axis. In the 5G system, for example, a total of 1008 different cell IDs may be defined. Depending on a physical layer cell ID (physical cell ID (PCI)) of a cell, the PSS 401 may have 3 different values, and the SSS 403 may have 336 different values. Via detection for the PSS 401 and the SSS 403, based on a combination thereof, a terminal may acquire one of 1008 (336×3=1008) cell IDs. This may be expressed by Equation 1 below.

$${N}_{ID}^{cell} = 3 {N}_{ID}^{( 1 )} + {N}_{ID}^{( 2 )} \qquad [ Equation 1 ]$$

Here, N_{ID}⁽¹⁾ may be estimated from the SSS 403 and may have a value of 0 to 335. N_{ID}⁽²⁾ may be estimated from the PSS 401 and may have a value of 0 to 2. The UE may estimate an N_{ID}^{(cell)} value as the cell ID by means of a combination of N_{ID}⁽¹⁾ and N_{ID}⁽²⁾.

The PBCH 402 may be transmitted in 24 RBs 406 on the frequency axis and in the second to fourth OFDM symbols of the SS block on the time axis, and specifically, may be transmitted in resources including 6 RBs 407 and 408 on both sides, except for the middle 12 RBs where the SSS 403 is transmitted in the third OFDM symbol of the SS block. The PBCH 402 may include a PBCH payload and a PBCH demodulation reference signal (DMRS), and various system information referred to as MIB may be transmitted in the PBCH payload. For example, an MIB may include information as in Table 2 below.

```
TABLE 2
MIB ::= SEQUENCE {
  systemFrameNumber BIT STRING (SIZE (6)),
  subCarrierSpacingCommon ENUMERATED {scs15or60, scs30or120},
  ssb-SubcarrierOffset INTEGER (0..15),
  dmrs-TypeA-Position ENUMERATED {pos2, pos3},
  pdcch-ConfigSIB1 PDCCH-ConfigSIB1,
  cellBarred ENUMERATED {barred, notBarred},
  intraFreqReselection ENUMERATED { allowed, notAllowed},
  spare BIT STRING (SIZE (1))
}
```

Synchronization signal block information: An offset of the frequency domain of the synchronization signal block may be indicated via 4-bit ssb-SubcarrierOffset in an MIB. An index of the synchronization signal block including the PBCH may be indirectly acquired via decoding of the PBCH and the PBCH DMRS. In an embodiment, in a frequency band below 6 GHz, 3 bits acquired via decoding of the PBCH DMRS may indicate the synchronization signal block index, and in a frequency band of 6 GHz or higher, a total of 6 bits, which includes 3 bits acquired via decoding of the PBCH DMRS and 3 bits which are included in the PBCH payload and acquired from PBCH decoding, may indicate the synchronization signal block index including the PBCH.

Physical downlink control channel (PDCCH) configuration information: A subcarrier spacing of a common downlink control channel may be indicated via 1 bit (subCarrierSpacingCommon) in an MIB, and time-frequency resource configuration information of a control resource set (CORESET) and a search space (SS) may be indicated via 8 bits (pdcch-ConfigSIB1).

System frame number (SFN): In an MIB, 6 bits (systemFrameNumber) may be used to indicate a part of an SFN. Least significant bit (LSB) 4 bits of the SFN may be included in the PBCH payload and indirectly acquired by the UE via PBCH decoding.

Timing information in a radio frame: Timing information is 1 bit (half frame) which is included in the aforementioned synchronization signal block index and PBCH payload, and acquired via PBCH decoding, and the terminal may indirectly identify whether the synchronization signal block has been transmitted in a first or second half frame of a radio frame.

The transmission bandwidth (12 RBs 401) for the PSS 401 and the SSS 403 is different from the transmission bandwidth (24 RBs 406) for the PBCH 402, so that, in a first OFDM symbol in which the PSS 402 is transmitted within the PBCH 402 transmission bandwidth, there exist 6 RBs 407 and 6 RBs 408 on both sides excluding 12 RBs while the PSS 401 is being transmitted, and the area may be used for transmitting another signal or may be empty.

Synchronization signal blocks may be transmitted using the same analog beam. For example, the PSS 401, the SSS 403, and the PBCH 402 may all be transmitted via the same beam. Since analog beams cannot be applied differently to the frequency axis, the same analog beam may be applied to all frequency axis RBs within a specific OFDM symbol to which a specific analog beam has been applied.

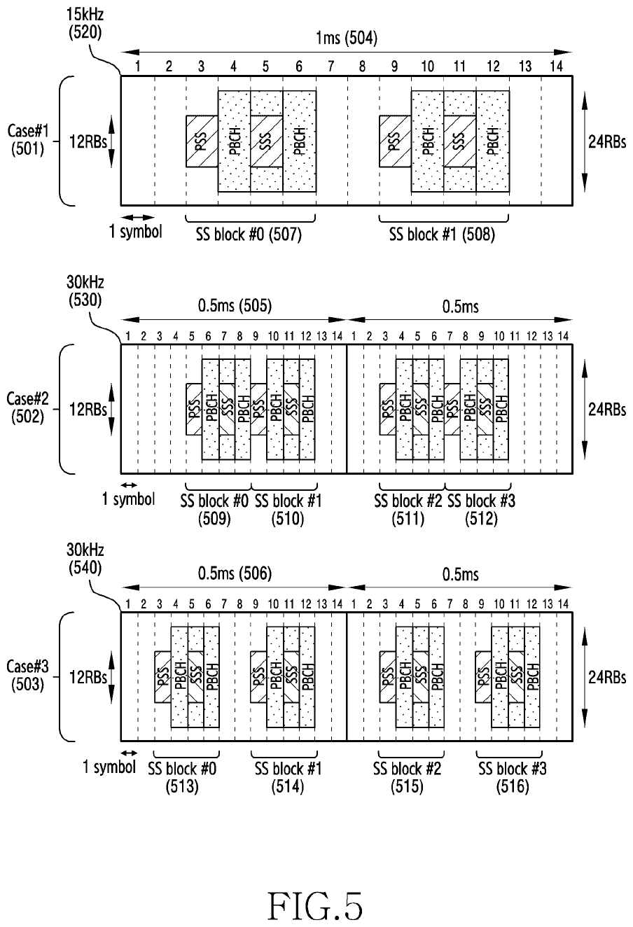

FIG. 5 illustrates examples of various transmission of a synchronization signal block in a frequency band below 6 GHz considered in a wireless communication system according to an embodiment of the disclosure;

Referring to FIG. 5, in the 5G communication system, a subcarrier spacing (SCS) 520 of 15 kHz and a subcarrier spacing (SCS) 530 or 540 of 30 kHz may be used for synchronization signal block transmission in a frequency band of 6 GHz or lower (or frequency range 1 (FR1), e.g., a frequency band of 410 MHz to 7,125 MHz). There may be one transmission case (e.g., case #1 501) for a synchronization signal block in the subcarrier spacing 520 of 15 kHz, and there may be two transmission cases (e.g., case #2 502 and case #3 503) for a synchronization signal block in the subcarrier spacing 530 or 540 of 30 kHz.

In FIG. 5, in case #1 520 with the subcarrier spacing 501 of 15 kHz, up to 2 synchronization signal blocks may be transmitted in 1 ms of time 504 (or corresponding to a length of 1 slot when 1 slot includes 14 OFDM symbols). In an example of FIG. 5, synchronization signal block #0 507 and synchronization signal block #1 508 are illustrated. For example, synchronization signal block #0 507 may be mapped to 4 consecutive symbols starting from a third OFDM symbol, and synchronization signal block #1 508 may be mapped to 4 consecutive symbols starting from a ninth OFDM symbol.

Different analog beams may be applied to synchronization signal block #0 507 and synchronization signal block #1 508. In addition, the same beam may be applied to all of the third to sixth OFDM symbols to which synchronization signal block #0 507 is mapped, and the same beam may be applied to all of the ninth to 12th OFDM symbols to which synchronization signal block #1 508 is mapped. With regard to beams to be used for seventh, eighth, 13th, and 14th OFDM symbols to which no synchronization signal block is mapped, an analog beam may be freely determined at the discretion of a base station.

In FIG. 5, in case #2 530 with the subcarrier spacing 502 of 30 kHz, up to 2 synchronization signal blocks may be transmitted in 0.5 ms of time 505 (or corresponding to a length of 1 slot when 1 slot includes 14 OFDM symbols), and accordingly, up to 4 synchronization signal blocks may be transmitted in 1 ms of time (or corresponding to a length of 2 slots when 1 slot includes 14 OFDM symbols). In an example of FIG. 5, a case where synchronization signal block #0 509, synchronization signal block #1 510, synchronization signal block #2 511, and synchronization signal block #3 512 are transmitted in 1 ms of time (i.e., two slots) is illustrated. Synchronization signal block #0 509 and synchronization signal block #1 510 may be mapped starting from a 5th OFDM symbol and a 9th OFDM symbol of a first slot, respectively, and synchronization signal block #2 511 and synchronization signal block #3 512 may be mapped starting from a 3rd OFDM symbol and a 7th OFDM symbol of a second slot, respectively.

Different analog beams may be applied to synchronization signal block #0 509, synchronization signal block #1 510, synchronization signal block #2 511, and synchronization signal block #3 512, respectively. In addition, the same analog beam may be applied to all of fifth to eighth OFDM symbols of a first slot in which synchronization signal block #0 509 is transmitted, ninth to 12th OFDM symbols of the first slot in which synchronization signal block #1 510 is transmitted, third to sixth symbols of a second slot in which synchronization signal block #2 511 is transmitted, and seventh to 10th symbols of the second slot in which synchronization signal block #3 512 is transmitted. With regard to beams to be used for OFDM symbols to which no synchronization signal block is mapped, analog beams may be freely determined at the discretion of a base station.

In FIG. 5, in case #3 540 with the subcarrier spacing 503 of 30 kHz, up to 2 synchronization signal blocks may be transmitted in 0.5 ms of time 506 (or corresponding to a length of 1 slot when 1 slot includes 14 OFDM symbols), and accordingly, up to 4 synchronization signal blocks may be transmitted in 1 ms of time (or corresponding to a length of 2 slots when 1 slot includes 14 OFDM symbols). In an example of FIG. 5, transmission of synchronization signal block #0 513, synchronization signal block #1 514, synchronization signal block #2 515, and synchronization signal block #3 516 in 1 ms of time (i.e., two slots) is illustrated. Synchronization signal block #0 513 and synchronization signal block #1 514 may be mapped starting from a third OFDM symbol and a ninth OFDM symbol of a first slot, respectively, and synchronization signal block #2 515 and synchronization signal block #3 516 may be mapped starting from a third OFDM symbol and a ninth OFDM symbol of a second slot, respectively.

Different analog beams may be applied to synchronization signal block #0 513, synchronization signal block #1 514, synchronization signal block #2 515, and synchronization signal block #3 516, respectively. As described in the examples above, the same analog beam may be used for all 4 OFDM symbols in which respective synchronization signal blocks are transmitted, and in OFDM symbols to which no synchronization signal block is mapped, beams to be used may be freely determined at the discretion of a base station.

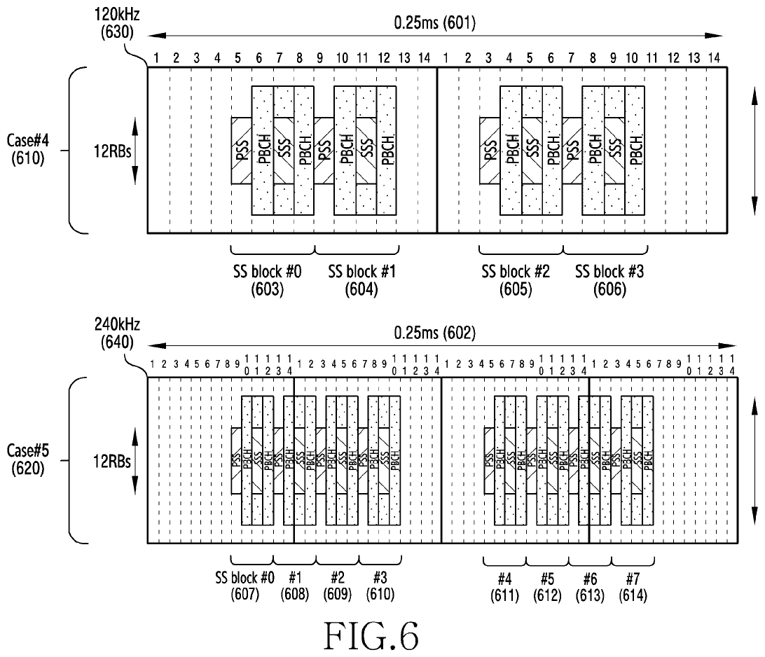

FIG. 6 illustrates an example of transmission of a synchronization signal block in a frequency band of 6 GHz or higher considered in a wireless communication system according to an embodiment of the disclosure;

In the 5G communication system, in a frequency band of 6 GHz or higher (or FR2, e.g., a frequency band of 24,250 MHz to 52,600 MHz), a subcarrier spacing % n of 120 kHz as shown in case #4% n and a subcarrier spacing % n of 240 kHz as shown in case #5% n may be used for synchronization signal block transmission.

In case #4 630 with the subcarrier spacing 610 of 120 kHz, up to 4 synchronization signal blocks may be transmitted in 0.25 ms of time 601 (or corresponding to a length of 2 slots when 1 slot includes 14 OFDM symbols). In an example of FIG. 6, a case where synchronization signal block #0 603, synchronization signal block #1 604, synchronization signal block #2 605, and synchronization signal block #3 606 are transmitted in 0.25 ms of time (i.e., two slots) is illustrated. Synchronization signal block #0 603 and synchronization signal block #1 604 may be respectively mapped to 4 consecutive symbols starting from a fifth OFDM symbol and to 4 consecutive symbols starting from a ninth OFDM symbol of a first slot, and synchronization signal block #2 605 and synchronization signal block #3 606 may be respectively mapped to 4 consecutive symbols starting from a third OFDM symbol and to 4 consecutive symbols starting from a seventh OFDM symbol of a second slot.

As described in the embodiment above, different analog beams may be used for synchronization signal block #0 603, synchronization signal block #1 604, synchronization signal block #2 605, and synchronization signal block #3 606, respectively. In addition, the same analog beam may be used for all 4 OFDM symbols in which respective synchronization signal block are transmitted, and in OFDM symbols to which no synchronization signal block is mapped, beams to be used may be freely determined at the discretion of a base station.

In case #5 640 with the subcarrier spacing 620 of 240 kHz, up to 8 synchronization signal blocks may be transmitted in 0.25 ms of time 602 (or corresponding to a length of 4 slots when 1 slot includes 14 OFDM symbols). In an example of FIG. 6, a case where synchronization signal block #0 607, synchronization signal block #1 608, synchronization signal block #2 609, synchronization signal block #3 610, synchronization signal block #4 611, synchronization signal block #5 612, synchronization signal block #6 613, and synchronization signal block #7 614 are transmitted in 0.25 ms of time (i.e., 4 slots) is illustrated.

Synchronization signal block #0 607 and synchronization signal block #1 608 may be respectively mapped to 4 consecutive symbols starting from a ninth OFDM symbol and to 4 consecutive symbols starting from a 13th OFDM symbol of a first slot, synchronization signal block #2 609 and synchronization signal block #3 610 may be respectively mapped to 4 consecutive symbols starting from a third OFDM symbol and to 4 consecutive symbols starting from a seventh OFDM symbol of a second slot, synchronization signal block #4 611, synchronization signal block #5 612, and synchronization signal block #6 613 may be respectively mapped to 4 consecutive symbols starting from a fifth OFDM symbol, to 4 consecutive symbols starting from a ninth OFDM symbol, and to 4 consecutive symbols starting from a 13th OFDM symbol of a third slot, and synchronization signal block #7 614 may be mapped to 4 consecutive symbols starting from a third OFDM symbol of a fourth slot.

As described in the embodiment above, different analog beams may be applied to synchronization signal block #0 607, synchronization signal block #1 608, synchronization signal block #2 609, synchronization signal block #3 610, synchronization signal block #4 611, synchronization signal block #5 612, synchronization signal block #6 613, and synchronization signal block #7 614, respectively. In addition, the same analog beam may be used for all 4 OFDM symbols in which respective synchronization signal block are transmitted, and in OFDM symbols to which no synchronization signal block is mapped, beams to be used may be freely determined at the discretion of a base station.

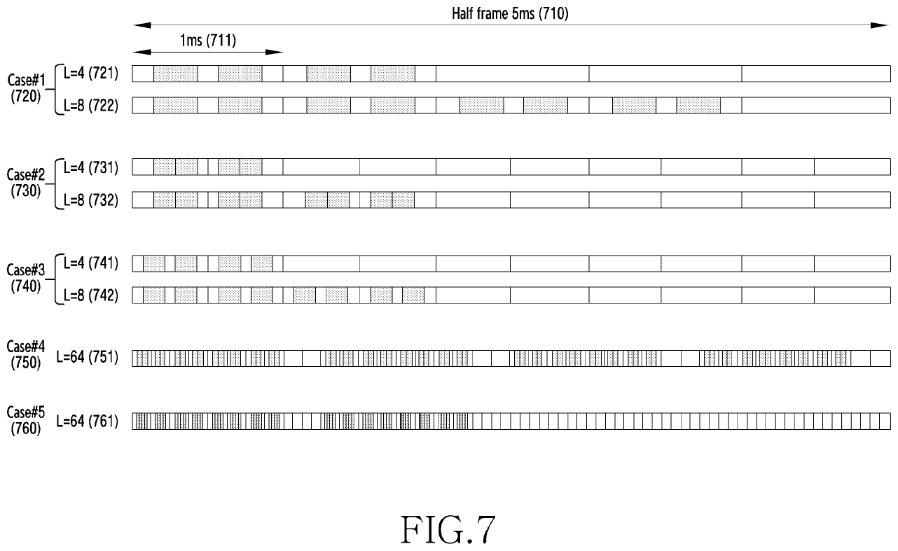

FIG. 7 illustrates examples of cases in which synchronization signal blocks are transmitted according to a subcarrier spacing within a time of 5 ms in a wireless communication system according to an embodiment of the disclosure.

Referring to FIG. 7, in a 5G communication system, synchronization signal blocks may be transmitted periodically at each time interval 710 of 5 ms, for example (corresponding to five subframes or half-frames).

In a frequency band of 3 GHz or less, a maximum of four synchronization signal blocks may be transmitted within a time of 5 ms 710. In a frequency band which exceeds 3 GHz and is equal to/less than 6 GHz, a maximum of eight synchronization signal blocks may be transmitted. In a frequency band exceeding 6 GHz, a maximum of 64 synchronization signal blocks may be transmitted. As described above, the subcarrier spacing of 15 kHz or 30 kHz may be used at a frequency of 6 GHz or less.

In the example in FIG. 7, and in case #1 501 of subcarrier spacing 15 kHz configured by one slot in FIG. 5, synchronization signal blocks may be mapped to the first and second slots in a frequency band of 3 GHz or less, and a maximum of four synchronization signal blocks 721 may thus be transmitted. In a frequency band which exceeds 3 GHz and is equal to/less than 6 GHZ, synchronization signal blocks may be mapped to the first, second, third, and fourth slots, and a maximum of eight synchronization signal blocks 722 may thus be transmitted. In in case #2 502 or case #3 503 of subcarrier spacing 30 kHz configured by two slots in FIG. 5, synchronization signal blocks may be mapped, starting from the first slot, in a frequency band of 3 GHz or less, and a maximum of four synchronization signal blocks 731 or 741 may thus be transmitted. In a frequency band which exceeds 3 GHz and is equal to/less than 6 GHZ, synchronization signal blocks may be mapped, starting from the first and third slots, and a maximum of eight synchronization signal blocks 732 or 742 may thus be transmitted.

Subcarrier spacings of 120kH and 240 kHz may be used at frequencies exceeding 6 GHz. In the example in FIG. 7, and in case #4 610 of subcarrier spacing 120 kHz configured by two slots in FIG. 6, synchronization signal blocks may be mapped, starting from the 1^{st}, 3^{rd}, 5^{th}, 7^{th}, 11^{th}, 13^{th}, 15^{th}, 17^{th}, 21^{st}, 23^{rd}, 25^{th}, 27^{th}, 31^{st}, 33^{rd}, 35^{th}, and 37^{th} slots, in a frequency band exceeding 6 GHz, and a maximum of 64 synchronization signal blocks 751 may thus be transmitted. In the example in FIG. 7, and in case #5 620 of subcarrier spacing 240 KHz configured by four slots in FIG. 6, synchronization signal blocks may be mapped, starting from the 1^{st} 5^{th}, 9^{th}, 13^{th}, 21^{st}, 25^{th}, 29^{th}, and 33^{rd} slots, in a frequency band exceeding 6 GHZ, and a maximum of 64 synchronization signal blocks 761 may thus be transmitted.

The UE may decode the PDCCH and PDSCH, based on system information included in the received MIB, and may then acquire an SIB. The SIB may include at least one from among uplink cell bandwidth-related information, a random access parameter, a paging parameter, or an uplink power control-related parameter.

In general, the UE may establish a radio link with a network through a random access procedure based on system information and synchronization with the network acquired in a cell search process. A contention-based random access scheme or a contention-free random access scheme may be used. In case that the UE performs cell selection and reselection in the initial access stage, the contention-based random access scheme may be used in order to transition from an RRC_IDLE state to an RRC_CONNECTED state, for example. The contention-free random access may be used in order to reconfigure uplink synchronization in case that downlink data has arrived, in the case of a handover, or in the case of position measurement. [Table 3] below enumerates conditions (events) that trigger a random access procedure in a 5G system.

TABLE 3
- Initial access from RRC_IDLE;
- RRC Connection Re-establishment procedure;
- DL or UL data arrival during RRC_CONNECTED when UL
synchronisation status is “non-synchronised”;
- UL data arrival during RRC_CONNECTED when there are no
PUCCH resources for SR available;
- SR failure;
- Request by RRC upon synchronous reconfiguration (e.g., handover);
- RRC Connection Resume procedure from RRC_INACTIVE;
- To establish time alignment for a secondary TAG;
- Request for Other SI;
- Beam failure recovery;
- Consistent UL LBT failure on SpCell.

Hereinafter, a measurement time configuration method for radio resource management (RRM) based on an SS block (or SSB) of a 5G wireless communication system will be described.

The UE has MeasObjectNR of MeasObjectToAddModList configured as configurations for intra/inter-frequency measurements based on an SSB and intra/inter-frequency measurements based on a channel state information-reference signal (CSI-RS) through higher layer signaling. For example, MeasObjectNR may be configured as in [Table 4] below:

TABLE 4
MeasObjectNR ::= SEQUENCE {

| | |
|---|---|
| ssbFrequency ARFCN-ValueNR | OPTIONAL, -- Cond SSBorAssociatedSSB |
| ssbSubcarrierSpacing SubcarrierSpacing | OPTIONAL, -- Cond SSBorAssociatedSSB |

```
  smtc1 SSB-MTC OPTIONAL, -- Cond SSBorAssociatedSSB
  smtc2 SSB-MTC2 OPTIONAL, -- Cond IntraFreqConnected
```

| | |
|---|---|
| refFreqCSI-RS ARFCN-ValueNR | OPTIONAL, -- Cond CSI-RS |

referenceSignalConfig ReferenceSignalConfig,

| | |
|---|---|
| absThreshSS-BlocksConsolidation ThresholdNR | OPTIONAL, -- Need R |

| | |
|---|---|
| absThreshCSI-RS-Consolidation ThresholdNR | OPTIONAL, -- Need R |

| | |
|---|---|
| nrofSS-BlocksToAverage INTEGER (2..maxNrofSS-BlockstoAverage) | OPTIONAL, -- |

Need R

nrofCSI-RS-ResourcesToAverage INTEGER (2..maxNrofCSI-RS-ResourcestoAverage)

```
OPTIONAL, -- Need R
  quantityConfigIndex INTEGER (1..maxNrofQuantityConfig),
  offsetMO Q-OffsetRangeList,
```

| | |
|---|---|
| cellsToRemoveList PCI-List | OPTIONAL, -- Need N |

| | |
|---|---|
| cellsToAddModList CellsToAddModList | OPTIONAL, -- Need N |

| | |
|---|---|
| blackCellsToRemoveList PCI-RangeIndexList | OPTIONAL, -- Need N |

| | |
|---|---|
| blackCellsToAddModList | SEQUENCE (SIZE (1..maxNrofPCI-Ranges)) OF PCI- |

RangeElement OPTIONAL, -- Need N

| | |
|---|---|
| whiteCellsToRemoveList PCI-RangeIndexList | OPTIONAL, -- Need N |

| | |
|---|---|
| whiteCellsToAddModList | SEQUENCE (SIZE (1..maxNrofPCI-Ranges)) OF PCI- |

RangeElement OPTIONAL, -- Need N

```
  ...,
  [[
```

| | |
|---|---|
| freqBandIndicatorNR FreqBandIndicatorNR | OPTIONAL, -- Need R |

| | |
|---|---|
| measCycleSCell | ENUMERATED {sf160, sf256, sf320, sf512, sf640, sf1024, sf1280} |

```
OPTIONAL, -- Need R
  ]],
  [[
```

| | |
|---|---|
| smtc3list-r16 SSB-MTC3List-r16 | OPTIONAL, -- Need R |

| | |
|---|---|
| rmtc-Config-r16 SetupRelease {RMTC-Config-r16} | OPTIONAL, -- Need M |

| | |
|---|---|
| t312-r16 SetupRelease { T312-r16 } | OPTIONAL -- Need M |
| ]] | |
| } | |

Terms in [Table 4] may perform the following functions. However, this is not limitative.

ssbFrequency: may configure the frequency of a synchronization signal related to MeasObjectNR.

ssbSubcarrierSpacing: configured the SSB's subcarrier spacing. FRI may apply only 15 kHz or 30 kHz, and FR2 may apply only 120 kHz or 240 kHz.

smtc1: denotes an SS/PBCH block measurement timing configuration, may configure a primary measurement timing configuration, and may configure the duration and timing offset and duration for the SSB.

smtc2: may configure a secondary measurement timing configuration for an SSB related to MeasObjectNR having a PCI listed in pci-List.

In addition, other types of higher layer signaling may be used for configurations. For example, an SMTC may be configured for the UE through reconfigurationWithSync for SIB2 for intra-frequency, inter-frequency and inter-RAT cell reselections, or for changing the NR PSCell and NR PCell, and an SMTC may be configured for the UE through SCellConfig to add an NR SCell.

The UE may configure the first SS/PBCH block measurement timing configuration (SMTC) according to periodictiyAndOffset (which provides periodicity and offset) through smtc1 configured higher layer signaling for SSB measurement. In an embodiment, the first subframe of each SMTC occasion may start in the subframe of the SpCell and system frame number (SFN) satisfying the conditions in [Table 5] below.

TABLE 5

SFN mod T = (FLOOR (Offset/10));
if the Periodicity is larger than sf5:
subframe = Offset mod 10;
else:
subframe = Offset or (Offset +5);
with T= CEIL(Periodicity/10).

If smtc2 is configured, the UE may configure an additional SMTC according to the periodicity of the configured smtc2 and the offset and duration of smtc1 for the sake of cells indicated by the pci-List value of smtc2 in the same MeasObjectNR. In addition, the UE may have an smtc configured through smtc2-LP (with long periodicity) for the same frequency (for example, frequency for intra frequency cell reselection) or different frequencies (for example, frequencies for inter frequency cell reselection) and smtc3list for integrated access and backhaul-mobile termination (IAB-MT), and may measure SSBs. In an embodiment, the UE may not consider SSBs transmitted in subframes other than SMTC occasions for SSB-based RRM measurement in configured ssbFrequency. The gNB may use various multi-transmit/receive point (TRP) operating schemes according to serving cell configurations and physical cell identifier (PCI) configurations. Among the same, in case that two TRPs positioned at a physical distance have different PCIs, the two TRPs may be operated in two methods.

### [Operating Method 1]

Two TRPs having different PCIs may be operated by two serving cell configurations.

The gNB may configure channels and signals transmitted in different TRPs by including them in different serving cell configurations through [operating method 1]. That is, respective TRPs have independent serving cell configurations, and frequency band values FrequencyInfoDL indicated by DownlinkConfigCommon in respective serving cell configurations may indicate at least partially overlapping bands. Various TRPs mentioned above operate based on multiple ServCellIndexes (for example, ServCellIndex #1 and ServCellIndex #2), and respective TRPs can thus use separate PCIs. That is, the gNB may allocate one PCI to each ServCellIndex.

In this case, in case that multiple SSBs are transmitted at TRP 1 and TRP 2, the SSBs have different PCIs (for example, PCI #1 and PCI #2), and the gNB may select an appropriate value of ServCellIndex indicated by a cell parameter in QCL-Info, may map suitable PCIs to respective TRPs, and may designate the SSB transmitted at one of TRP 1 or TRP 2 as the source reference RS of QCL configuration information. However, such configurations have a problem in that the degree of freedom of CA configurations is limited, or the signaling burden is increased, because one serving cell configuration that may be used for the UE's carrier aggregation (CA) is applied to multiple TRPs.

### [Operating Method 2]

Two TRPs having different PCIs may be operated by one serving cell configuration.

The gNB may configure channels and signals transmitted in different TRPs through by one serving cell configuration according to [operating method 2]. The UE operates based on one ServCellIndex (for example, ServCellIndex #1) and may thus fail to recognize the PCI (for example, PCI #2) allocated to the second TRP. Compared with [operating method 1] described, [operating method 2] may have a degree of freedom in connection with CA configurations, but if multiple SSBs are transmitted at TRP 1 and TRP 2, the SSBs have different PCIs (for example, PCI #1 and PCI #2), and the gNB may fail to map the PCI (for example, PCI #2) of the second TRP through the ServCellIndex indicated by a cell parameter in QCL-Info. The gNB may designate the SSB transmitted at TRP 1 as the source reference RS of QCL configuration information, and may fail to designate the SSB transmitted at TRP 2.

As described above, [operating method 1] may be performed based on multi-TRP operations regarding two TRPs having different PCIs through additional serving cell configurations without additional specification support, but [operating method 2] may be performed based on an additional UE capability report and the gNB's configuration information described below:

Regarding UE capability report for [operating method 2]

The UE may report UE capability to the gNB to indicate that an additional PCI different from the serving cell's PCI can be configured through higher layer signaling from the gNB. The UE capability may include two independent numbers X1 and X2, or X1 and X2 may be reported as independent UE capabilities.

X1 refers to the maximum number of additional PCIs that may be configured for the UE, the PCIs may differ from the serving cell's PCI, and the time domain position and periodicity of the SSB corresponding to the additional PCIs may indicate that the same is identical to the serving cell's SSB.

X2 refers to the maximum number of additional PCIs that may be configured for the UE, the PCIs may differ from the serving cell's PCI, and the time domain position and periodicity of the SSB corresponding to the additional PCIs may indicate that the same is different from the SSB corresponding to PCIs reported by X1.

By definition, PCIs corresponding to values reported by X1 and X2 cannot be configured simultaneously with each other.

each of the values reported by X1 and X2 reported through the UE capability report may have an integer value from 0 to 7.

The values reported by X1 and X2 may differ from each other in FRI and FR2.

Regarding higher layer signaling configuration for [operating method 2]

The UE may have SSB-MTCAdditionalPCI-r17 (higher layer signaling) configured by the gNB, based on the above-described UE capability report. The higher layer signaling may include multiple additional PCIs having values different from the serving cell at least, SSB transmission power corresponding to each additional PCI, and ssb-PositionInBurst corresponding to each additional PCI. The maximum number of configurable additional PCIs may be 7.

The UE may expect that an SSB corresponding to an additional PCI having a different value from the serving cell may have the same center frequency, subcarrier spacing, and subframe number offset as the serving cell's SSB.

The UE may expect that a reference RS (for example, SSB or CSI-RS) corresponding to the serving cell's PCI is always connected to an activated TCI state, and may expect that, in case that one or multiple additionally configured PCIs having a different value from the serving cell, only one of the PCIs is connected to the activated TCI state.

In case that the UE has two different coresetPoolIndexes configured therefor, a reference RS corresponding to the serving cell's PCI is connected to one or multiple activated TCI states, and a reference RS corresponding to an additionally configured PCI having a different value from the serving cell is connected to one or multiple activated TCI states, the UE may expect that TCI state(s) connected to the serving cell PCI are connected to one of the two coresetPoolIndexes, and activated TCI state(s) connected to the additionally configured PCI having a different value from the serving cell are connected to the remaining one coresetPool Index.

The UE capability reporting and the gNB's higher layer signaling for [operating method 2] described above may configure an additional PCI having a different value from the serving cell's PCI. In case that the configuration does not exist, an SSB corresponding to an additional PCI having a different value from the serving cell's PCI, which cannot be designated by a source reference RS, may be used to designate the same by QCL configuration information's source reference RS. In addition, unlike an SSB that may be configured to be used for RRM, mobility, handover, or other usages as in the case of configuration information regarding an SSB that may be configured in smtc1 and smtc2 (higher layer signaling) described above, the same may be used for a role as a QCL source RS for supporting operations of multiple TRPs having different PCIs.

Next, a demodulation reference signal (DMRS) which is one of reference signals in 5G systems will be described in detail.

A DMRS may be configured by multiple DMRS ports, and respective ports maintain orthogonality so as not to cause mutual interference by using code division multiplexing (CDM) or frequency division multiplexing (FDM). However, terms regarding the DMRS may be expressed by others according to the user's intent and the purpose of use of reference signals. The term “DMRS” is only a specific example presented to easily describe the technical details of the disclosure and to help understanding of the disclosure, and is not intended to limit the scope of the disclosure. That is, it is obvious to those skilled in the art that the technical idea of the disclosure is applicable to any reference signal.

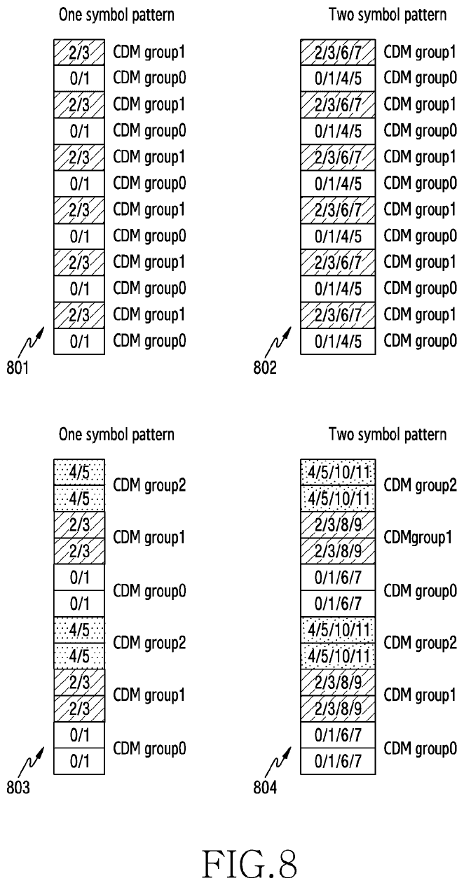

FIG. 8 illustrates an example of DMRS patterns (type 1 and type 2) used for communication between a gNB and a UE in a wireless communication system according to an embodiment of the disclosure.

A 5G system may support two DMRS patterns.

FIG. 8 illustrates DMRS type 1 801 and 802. More specifically, FIG. 8 illustrates a one-symbol pattern 801 and a two-symbol pattern 802. DMRS type 1 801 and 802 is a DMRS pattern having comb 2 structure, and may be configured by two CDM groups, and different CDM groups may be FDMed.

In the one-symbol pattern 801, frequency-based CDM may be applied to the same CDM group, thereby distinguishing two DMRS ports, and a total of four orthogonal DMRS ports may thus be configured. The one-symbol pattern 801 may include DMRS port IDs mapped to respective CDM groups (downlink-related DMRS port ID may be indicated by illustrated number+1000). In the two-symbol pattern 802, time/frequency-based CDM may be applied to the same CDM group, thereby distinguishing four DMRS ports, and a total of eight orthogonal DMRS ports may thus be configured. The two-symbol pattern 802 may include DMRS port IDs mapped to respective CDM groups (downlink-related DMRS port ID may be indicated by illustrated number+1000).

FIG. 8 illustrates DMRS type 2 803 and 804 as a DMRS pattern configured such that frequency domain orthogonal cover codes (FD-OCC) are applied to adjacent subcarriers in the frequency domain. The same may be configured by three CDM groups, and different CDM groups may be FDMed.

In the one-symbol pattern 803, frequency-based CDM may be applied to the same CDM group, thereby distinguishing two DMRS ports, and a total of six orthogonal DMRS ports may thus be configured. The one-symbol pattern 803 may include DMRS port IDs mapped to respective CDM groups (downlink-related DMRS port ID may be indicated by illustrated number+1000). In the two-symbol pattern 804, time/frequency-based CDM may be applied to the same CDM group, thereby distinguishing four DMRS ports, and a total of twelve orthogonal DMRS ports may thus be configured. The two-symbol pattern 804 may include DMRS port IDs mapped to respective CDM groups (downlink-related DMRS port ID may be indicated by illustrated number+1000).

As described above, in an NR system, two different DMRS patterns (for example, DMRS type 1 801 and 802 or DMRS type 2 803 and 804) may be configured, and it may also be configured whether respective DMRS patterns are one-symbol patterns 801 and 803 or adjacent two-symbol patterns 802 and 804. In addition, in an NR system, not only DMRS port numbers are scheduled, but the number of CDM groups scheduled together for PDSCH rate matching may also be configured and signaled. In addition, in the case of cyclic prefix based orthogonal frequency division multiplex (CP-OFDM), the above-described two DMRS patterns may both be supported in the DL and UL. In the case of discrete Fourier transform spread OFDM (DFT-S-OFDM), only DMRS type 1 801 and 802 among the above-described DMRS patterns may be supported in the UL.

In addition, configurable additional DMRSs may be supported. A front-loaded DMRS refers to the first DMRS transmitted/received in the foremost symbol in the time domain among DMRSs, and an additional DMRS refers to the DMRS transmitted/received in a symbol that follows the symbol of the front-loaded DMRS. In an NR system, the configured number of additional DMRSs may be a minimum of 0 to a maximum of 3. In addition, in case that additional DMRSs are configured, the same pattern as front-loaded DMRSs may be assumed. In an embodiment, in case of indicating information regarding whether the above-described DMRS pattern type is type 1 or type 2 with regard to a front-loaded DMRS, information regarding whether the DMRS pattern is a one-symbol pattern or an adjacent two-symbol pattern, and information regarding the number of CDM groups used with DMRS ports, and in case that an additional DMRS is configured, it may be assumed that the same DMRS information as the front-loaded DMRS is configured for the additional DMRS.

In an embodiment, the above-described downlink DMRS configuration may be configured through RRC signaling as in [Table 6] below:

TABLE 6

| DMRS-DownlinkConfig ::= SEQUENCE { | |
|---|---|
| dmrs-Type ENUMERATED {type2} | OPTIONAL, -- Need S |
| dmrs-AdditionalPosition ENUMERATED {pos0, pos1, pos3 } | |
| OPTIONAL, -- Need S | |
| maxLength ENUMERATED {len2} | OPTIONAL, -- Need S |
| scramblingID0 INTEGER (0..65535) | OPTIONAL, -- Need S |

scramblingID1 INTEGER (0..65535)
phaseTrackingRS SetupRelease {PTRS-DownlinkConfig}
OPTIONAL, -- Need M
...
}

wherein dmrs-Type may configure a DMRS type, and dmrs-AdditionalPosition may configure additional DMRS OFDM symbols. maxLength may configure a one-symbol DMRS pattern or a two-symbol DMRS pattern. scramblingIDO and scramblingID1 may configure scrambling IDs. phaseTrackingRS may configure a phase tracking reference signal (PTRS). In addition, the above-described uplink DMRS configuration may be configured through RRC signaling as in [Table 7] below.

```
TABLE 7
DMRS-UplinkConfig ::= SEQUENCE {
  dmrs-Type ENUMERATED {type2} OPTIONAL, -- Need S
  dmrs-AdditionalPosition ENUMERATED {pos0, pos1, pos3 }
  OPTIONAL, -- Need R
  phaseTrackingRS SetupRelease { PTRS-UplinkConfig }
  OPTIONAL, -- Need M
  maxLength ENUMERATED {len2} OPTIONAL, -- Need S
  transformPrecodingDisabled SEQUENCE {
```

| | |
|---|---|
| scramblingID0 INTEGER (0..65535) | OPTIONAL, -- Need S |
| scramblingID1 INTEGER (0..65535) | OPTIONAL, -- Need S |

...

| | |
|---|---|
| } | OPTIONAL, -- Need R |

transformPrecodingEnabled SEQUENCE {

| | |
|---|---|
| nPUSCH-Identity INTEGER (0..1007) | OPTIONAL, -- Need S |

```
    sequenceGroupHopping ENUMERATED { disabled} OPTIONAL, -- Need S
    sequenceHopping ENUMERATED {enabled} OPTIONAL, -- Need S
    ...
```

| | |
|---|---|
| } | OPTIONAL, -- Need R |

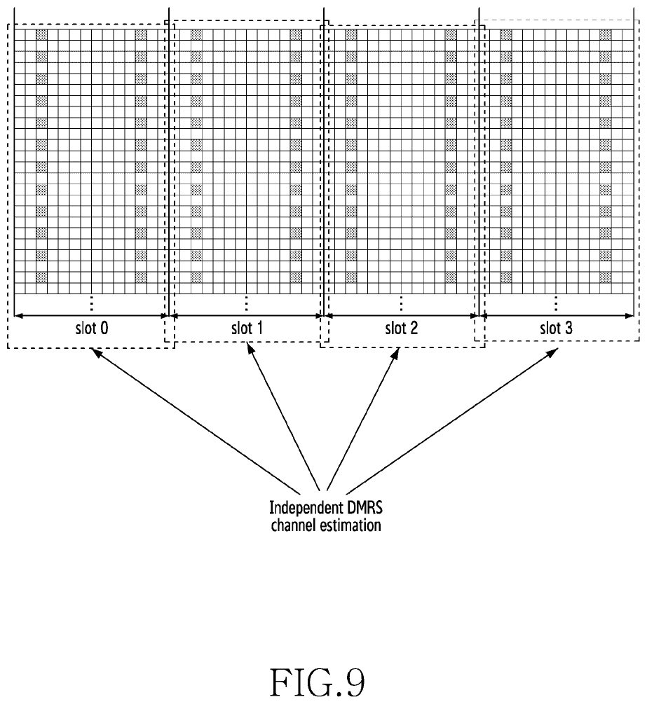

...
}

Wherein dmrs-Type may configure a DMRS type, and dmrs-AdditionalPosition may configure additional DMRS OFDM symbols. phaseTrackingRS may configure PTRS, and maxLength may configure a one-symbol DMRS pattern or a two-symbol DMRS pattern. scramblingIDO and scramblingID1 may configure scrambling IDs, and nPUSCH-Identity may configure a cell ID for DFT-s-OFDM. sequenceGroupHopping may disable sequence group hopping, and sequenceHopping may enable sequence hopping. FIG. 9 illustrates an example of channel estimation using a DMRS received in one PUSCH in the time domain of a wireless communication system according to an embodiment of the disclosure.

Referring to FIG. 9, in connection with performing channel estimation for data decoding by using a DMRS, bundling of physical resource blocks (PRBs) interworking with system bands may be used in the frequency domain to perform channel estimation within a precoding resource block group (PRG) which is the bundling unit. In addition, channel estimation may be performed based on an assumption that DMRSs received in only one PUSCH solely have the same precoding in the time domain.

Hereinafter, a time domain resource allocation (TDRA) method regarding a data channel in a 5G communication system will be described. A gNB may configure a TDRA information table regarding a physical downlink shared channel (PDSCH) and a physical uplink shared channel (PUSCH) for a UE through higher layer signaling (for example, RRC signaling).

The gNB may configure a table configured by a maximum of maxNrofDL-Allocations=17 entries with regard to the PDSCH, and may configure a table configured by a maximum of maxNrofUL-Allocations=17 entries with regard to the PUSCH. TDRA information may include, for example, at least one from among PDCCH-to-PDSCH slot timing (which is indicated by KO, corresponding to a slot-unit time interval between a timepoint at which a PDCCH is received and a timepoint at which a PDSCH that schedules the received PDCCH is transmitted) or PDCCH-to-PUSCH slot timing (which is indicated by K2, corresponding to a slot-unit time interval between a timepoint at which a PDCCH is received and a timepoint at which a PUSCH that schedules the received PDCCH is transmitted) or PDCCH-to-PUSCH), information regarding the position and length of a starting symbol having a PDSCH or PUSCH scheduled therefor in a slot, and the PDSCH or PUSCH's mapping type.

In an embodiment, TDRA information regarding the PDSCH may be configured for the UE through RRC signaling as in [Table 8] below.

TABLE 8
PDSCH-TimeDomainResourceAllocationList information element

PDSCH-TimeDomainResourceAllocationList ::= SEQUENCE (SIZE
(1 .. maxNrofDL-Allocations)) OF PDSCH-TimeDomainResourceAllocation

| | |
|---|---|
| PDSCH-TimeDomainResourceAllocation ::= | SEQUENCE { |

k0 INTEGER(0..32) OPTIONAL, -- Need S
mappingType ENUMERATED {typeA, typeB},
startSymbolAndLength INTEGER (0..127)
repetitionNumber ENUMERATED {n2, n3, n4, n5, n6, n7, n8, n16}
OPTIONAL, -- Cond
Formats1-0and1-1
}

wherein k0 may be a slot-based representation of PDCCH-to-PDSCH timing (that is, the slot offset between DCI and its scheduled PDSCH), and mappingType may indicate a mapping type. startSymbolAndLength may indicate the PDSCH's starting symbol and length, and repetitionNumber may indicate the number of PDSCH transmission occasions according to a slot-based repetition scheme. In an embodiment, TDRA information regarding the PUSCH may be configured for the UE through RRC signaling as in [Table 9] below.

TABLE 9
PUSCH-TimeDomainResourceAllocation information element

| | |
|---|---|
| PUSCH-TimeDomainResourceAllocationList ::= | SEQUENCE (SIZE |

(1 .. maxNrofUL-Allocations)) OF PUSCH-TimeDomainResourceAllocation

| | |
|---|---|
| PUSCH-TimeDomainResourceAllocation ::= | SEQUENCE { |

k2 INTEGER(0..32) OPTIONAL, Need S
mappingType ENUMERATED {typeA, typeB},

startSymbolAndLength INTEGER (0..127)
}
PUSCH-Allocation-r16 ::= SEQUENCE {

mappingType-r16 ENUMERATED {typeA, typeB} OPTIONAL, -- Cond

NotFormat01-02-Or-TypeA

startSymbolAndLength-r16 INTEGER (0..127) OPTIONAL, -- Cond

NotFormat01-02-Or-TypeA

```
  startSymbol-r16 INTEGER (0..13) OPTIONAL, -- Cond RepTypeB
  length-r16 INTEGER (1..14) OPTIONAL, -- Cond RepTypeB
  numberOfRepetitions-r16 ENUMERATED {n1, n2, n3, n4, n7, n8, n12, n16}
OPTIONAL, -- Cond Format01-02
  ...
}
```

Wherein k2 may be a slot-based representation of PDCCH-to-PUSCH timing (that is, the slot offset between DCI and its scheduled PUSCH), and mappingType may indicate a PUSCH mapping type. startSymbolAndLength or StartSymbol or length may indicate the PUSCH's starting symbol and length, and numberOfRepetitions may indicate the number of repetitions used for PUSCH transmission. The gNB may indicate at least one of the entries of the table regarding TDRA information to the UE through L1 signaling (for example, downlink control information (DCI)) (for example, “TDRA” filed in the DCI may indicate the same). The UE may acquire TDRA information regarding the PDSCH or PUSCH, based on the DCI received from the gNB.

Hereinafter, physical uplink shared channel (PUSCH) transmission in a 5G system will be described. PUSCH transmission may be dynamically scheduled by a UL grant inside DCI (for example, referred to as dynamic grant (DG)-PUSCH), or may be scheduled by means of configured grant Type 1 or Type 2 (for example, referred to as configured grant (CG)-PUSCH). Dynamic scheduling for PUSCH transmission may be indicated by DCI format 0_0 or 0_1.

Configured grant Type 1 PUSCH transmission may be configured semi-statically by receiving configuredGrantConfig including rrc-ConfiguredUplinkGrant in Table 16 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 16 through upper signaling.

In an embodiment, if PUSCH transmission is operated by a configured grant, parameters applied to the PUSCH transmission are applied through configuredGrantConfig (upper signaling) in Table 10 except for dataScramblingIdentityPUSCH, txConfig, codebookSubset, maxRank, and scaling of UCI-OnPUSCH, which are provided by pusch-Config (upper signaling) in Table 11. If provided with transformPrecoder inside configuredGrantConfig (upper signaling) in Table 18, the UE applies tp-pi2BPSK inside pusch-Config in Table 19 to PUSCH transmission operated by a configured grant.

TABLE 10
ConfiguredGrantConfig

```
  ConfiguredGrantConfig ::= SEQUENCE {
  frequencyHopping ENUMERATED {intraSlot, interSlot} OPTIONAL, Need S,
  cg-DMRS-Configuration DMRS-UplinkConfig,
  mcs-Table ENUMERATED {qam256, qam64LowSE} OPTIONAL, -- Need S
  mcs-TableTransformPrecoder ENUMERATED {qam256, qam64LowSE}
OPTIONAL, -- Need S
  uci-OnPUSCH SetupRelease { CG-UCI-OnPUSCH } OPTIONAL, -- Need M
```

| | |
|---|---|
| resourceAllocation | ENUMERATED { resourceAllocationType0, |

resourceAllocationType1, dynamicSwitch },

| | |
|---|---|
| rbg-Size | ENUMERATED {config2} OPTIONAL, -- Need S |

```
  powerControlLoopToUse ENUMERATED {n0, n1},
  p0-PUSCH-Alpha P0-PUSCH-AlphaSetId,
```

| | |
|---|---|
| transformPrecoder | ENUMERATED {enabled, disabled} OPTIONAL, -- Need S |

nrofHARQ-Processes INTEGER(1..17),

| | |
|---|---|
| repK | ENUMERATED {n1, n2, n4, n8}, |

| | |
|---|---|
| repK-RV | ENUMERATED {s1-0231, s2-0303, s3-0000} OPTIONAL, -- Need R |

| | |
|---|---|
| periodicity | ENUMERATED { |

```
  sym2, sym7, sym1×14, sym2×14, sym4×14, sym5×14, sym8×14, sym10×14,
sym17×17, sym20×14,
  sym32×14, sym40×14, sym64×14, sym80×14, sym128×14, sym170×14, sym256×14,
sym320×14, sym512×14
  sym640×14, sym1024×14, sym2560×14, sym5120×14,
  sym6, sym1×12, sym2×12, sym4×12, sym5×12, sym8×12, sym10×12, sym17×12,
sym20×12, sym32×12,
  sym40×12, sym64×12, sym80×12, sym128×12, sym170×12, sym256×12,
sym320×12, sym512×12, sym640×12,
  sym1280×12, sym2560×12
  },
  configuredGrantTimer INTEGER (1..64) OPTIONAL, -- Need R
  rrc-ConfiguredUplinkGrant SEQUENCE {
    timeDomainOffset INTEGER (0..5119),
    timeDomainAllocation INTEGER (0..16),
    frequencyDomainAllocation BIT STRING (SIZE(18)),
    antennaPort INTEGER (0..31),
    dmrs-SeqInitialization INTEGER (0..1) OPTIONAL, -- Need R
    precodingAndNumberOfLayers INTEGER (0..63),
    srs-ResourceIndicator INTEGER (0..16) OPTIONAL, --Need R
    mcsAndTBS INTEGER (0..31),
    frequencyHoppingOffset INTEGER (1.. maxNrofPhysicalResourceBlocks-1)
OPTIONAL, -- Need R
    pathlossReferenceIndex INTEGGER (0..maxNrofPUSCH-PathlossReferenceRSs-1),
    ...
```

| | |
|---|---|
| } | OPTIONAL, -- Need R |
| ... | |
| } | |

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 11, which is upper signaling, is “codebook” or “nonCodebook.” As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource having the minimum ID inside an activated uplink bandwidth part (BWP) in a serving cell. In an embodiment, the PUSCH transmission may be performed based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 11, the UE does not expect scheduling through DCI format 0_1.

TABLE 11
PUSCH-Config

```
  PUSCH-Config ::= SEQUENCE {
  dataScramblingIdentityPUSCH INTEGER (0..1023) OPTIONAL, -- Need S
```

| | |
|---|---|
| txConfig | ENUMERATED {codebook, nonCodebook} OPTIONAL, Need S |

```
  dmrs-UplinkForPUSCH-MappingTypeA SetupRelease { DMRS-UplinkConfig }
OPTIONAL, -- Need M
  dmrs-UplinkForPUSCH-MappingTypeB SetupRelease { DMRS-UplinkConfig }
OPTIONAL, -- Need M
```

| | |
|---|---|
| pusch-PowerControl | PUSCH-PowerControl OPTIONAL, -- Need M |

| | |
|---|---|
| frequencyHopping | ENUMERATED {intraSlot, interSlot} OPTIONAL, -- Need S |

| | |
|---|---|
| frequencyHoppingOffsetLists | SEQUENCE (SIZE (1..4)) OF INTEGER (1.. |

maxNrofPhysicalResourceBlocks-1) OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

TimeDomainResourceAllocationList } OPTIONAL, -- Need M
pusch-AggregationFactor ENUMERATED { n2, n4, n8 } OPTIONAL, -- Need S

| | |
|---|---|
| mcs-Table | ENUMERATED { qam256, qam64LowSE} OPTIONAL, -- Need S |

| | |
|---|---|
| mcs-Table TransformPrecoder | ENUMERATED{qam256, qam64LowSE} |

OPTIONAL, -- Need S
transformPrecoder ENUMERATED {enabled, disabled} OPTIONAL, -- Need S

| | | |
|---|---|---|
| codebookSubset | ENUMERATED | {fully AndPartial AndNonCoherent, |

partialAndNonCoherent, nonCoherent}
OPTIONAL, -- Cond codebookBased

| | |
|---|---|
| maxRank | INTEGER (1..4) OPTIONAL, -- Cond codebookBased |
| rbg-Size | ENUMERATED { config2 } OPTIONAL, -- Need S |

| | |
|---|---|
| uci-OnPUSCH | SetupRelease { UCI-OnPUSCH} OPTIONAL, -- Need M |

| | |
|---|---|
| tp-pi2BPSK | ENUMERATED {enabled} OPTIONAL, -- Need S |

...
}

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers). The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI may be used to indicate a precoder to be applied to PUSCH transmission.

The precoder to be used for PUSCH transmission may be selected from an uplink codebook having the same number of antenna ports as the value of nrofSRS-Ports inside SRS-Config (upper signaling). In connection with codebook-based PUSCH transmission, the UE may determine a codebook subset, based on codebook Subset inside pusch-Config (upper signaling) and TPMI. The codebookSubset inside pusch-Config (upper signaling) may be configured to be one of “fullyAndPartial AndNonCoherent,” “partialAndNonCoherent,” or “noncoherent,” based on UE capability reported by the UE to the base station.

If the UE reported “partial AndNonCoherent” as UE capability, the UE may not expect that the value of codebookSubset (upper signaling) may be configured as “fully AndPartialAndNonCoherent.” In addition, if the UE reported “nonCoherent” as UE capability, UE may not expect that the value of codebookSubset (upper signaling) may be configured as “fully AndPartialAndNonCoherent” or “partial AndNonCoherent.” If nrofSRS-Ports inside SRS-ResourceSet (upper signaling) indicates two SRS antenna ports, the UE does not expect that the value of codebookSubset (upper signaling) may be configured as “partial AndNonCoherent.”

The UE may have one SRS resource set configured therefor, wherein the value of usage inside SRS-ResourceSet (upper signaling) is “codebook,” and one SRS resource may be indicated through an SRI inside the corresponding SRS resource set. If multiple SRS resources are configured inside the SRS resource set wherein the value of usage inside SRS-ResourceSet (upper signaling) is “codebook,” the UE may expect that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. As described above, PUSCH transmission may be dynamically scheduled through DCI format 0_0 or 0_1, and may be semi-statically configured by a configured grant. If at least one SRS resource is configured inside an SRS resource set wherein the value of usage inside SRS-ResourceSet (upper signaling) is “nonCodebook,” non-codebook-based PUSCH transmission may be scheduled for the UE through DCI format 0_1.

With regard to the SRS resource set wherein the value of usage inside SRS-ResourceSet (upper signaling) is “nonCodebook,” one non-zero-power (NZP) CSI-RS resource associated with the SRS resource set may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission may be updated.

If the configured value of resourceType inside SRS-ResourceSet (upper signaling) is “aperiodic,” the connected NZP CSI-RS may be indicated by an SRS request which is a field inside DCI format 0_1 or 1_1. In an embodiment, if the NZP CSI-RS resource associated with the SRS-ResourceSet is an aperiodic NZP CSI-RS resource and the value of field SRS request inside DCI format 0_1 or 1_1 is not “00,” this case may indicate the existence of the NZP CSI-RS associated with the SRS-ResourceSet. The DCI may not indicate cross carrier or cross BWP scheduling. If the value of SRS request indicates the existence of a NZP CSI-RS, the NZP CSI-RS may be located in the slot used to transmit the PDCCH including the SRS request field. TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE may not expect that spatialRelationInfo which is upper signaling regarding the SRS resource and associatedCSI-RS inside SRS-ResourceSet (upper signaling) may be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook,” and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook,” and the base station may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE may transmit the PUSCH by applying the precoder applied to SRS resource transmission to each layer.

Hereinafter, a method for repeatedly transmitting a PUSCH and transmitting a single transport block (TB) through multiple slots, in a 5G system, will be described. A 5G system may support two types of PUSCH repeated transmission methods (for example, PUSCH repeated transmission type A and PUSCH repeated transmission type B), and TB processing over multi-slot PUSCH (TBoMS) according to which a single TB is used to transmit multiple PUSCHs over multiple slots. In addition, the UE may have one of PUSCH repeated transmission type A and PUSCH repeated transmission type B configured therefor through higher layer signaling. In addition, the UE may have numberOfSlotsTBoMS configured therefor through a resource allocation table and may then transmit TBOMS.

PUSCH repeated transmission type A

As described above, the PUSCH's starting symbol and length may be determined by the TDRA method in one slot, and the gNB may transmit the number of repeated transmissions to the UE through higher layer signaling (for example, RRC signaling) or L1 signaling (for example, DCI). The number (N) of slots configured by numberOfSlotsTBoMS in order to determine the transport block size (TBS) is 1.

The UE may repeatedly transmit a PUSCH having the same starting symbol and length as the PUSCH configured above, based on the number of repeated transmissions received from the gNB, in consecutive slots. In an embodiment, in case that at least one of symbols in a slot configured as the downlink for the UE by the gNB, or in a slot for PUSCH repeated transmission configured for the UE, is configured as the downlink, the UE may omit PUSCH transmission in the corresponding slot. For example, the UE may transmit no PUSCH within the number of repeated transmissions of the PUSCH. On the other hand, a UE that supports Rel-17 uplink data repeated transmission may determine that a slot in which uplink data repeated transmission is possible is an available slot, and may count the number of transmissions during PUSCH repeated transmission with regard to the slot deemed to be an available slot. In case that repeated transmission of the PUSCH in the slot deemed to be an available slot is omitted, repeated transmission may be performed through a slot in which transmission is possible after postponement. By using [Table 12] below, a redundancy version may be applied according to the redundancy version pattern configured for each nth PUSCH transmission occasion.

PUSCH repeated transmission type B

As described above, the PUSCH's starting symbol and length may be determined by the TDRA method in one slot, and the gNB may transmit the number of repeated transmissions, umberofrepetitions, to the UE through higher layer signaling (for example, RRC signaling) or L1 signaling (for example, DCI). In an embodiment, the number (N) of slots configured by numberOfSlotsTBoMS in order to determine the TBS is 1.

Firstly, based on the PUSCH's starting symbol and length configured above, the PUSCH's nominal repetition may be determined as follows. As used herein, nominal repetition may refer to symbol resources configured by the gNB for PUSCH repeated transmission, and the UE may determine resources that may be used as the uplink from the configured nominal repetition. In this case, the slot in which the n^{th} nominal repetition starts may be given by

$${K}_{s} + ⌊ \frac{S + n \cdot L}{{N}_{symb}^{slot}} ⌋ ,$$

and the symbol at which the nominal repetition starts in the starting symbol may be given by mod(S+n·L, N_{symb}^{slot}). The slot in which the n^{th} nominal repetition end may be given by

$${K}_{s} + ⌊ \frac{S + ( n + 1 ) \cdot L - 1}{{N}_{symb}^{slot}} ⌋ ,$$

and the symbol at which the nominal repetition ends in the last symbol may be given by mod(S+(n+1)·L−1. N_{symb}^{slot}). In this regard, n=0, . . . , numberofrepetitions-1, S may denote the configured PUSCH's starting symbol, and L may denote the configured PUSCH's symbol length. Kₛ may denote the slot at which PUSCH transmission starts, and N_{symb}^{slot} may denote the number of symbols per slot.

The UE may determine an invalid symbol for PUSCH repeated transmission type B. A symbol configured as the downlink by tdd-UL-DL-ConfigurationCommon or tdd-UL-DL-ConfigurationDedicated may be deemed to be an invalid symbol for PUSCH repeated transmission type B. Additionally, an invalid symbol may be configured based on a higher layer parameter (for example, InvalidSymbolPattern). As an example, the higher layer parameter (for example, InvalidSymbolPattern) may provide a symbol level bitmap across one slot or two slots, thereby determining an invalid symbol. In an embodiment, mark “1” in the bitmap may indicate an invalid symbol. Additionally, the bitmap's periodicity and pattern may be configured through a higher layer parameter (for example, periodicityAndPattern). If a higher layer parameter (for example, InvalidSymbolPattern) is configured, and if parameter InvalidSymbolPatternIndicator-ForDCIFormat0_1 or InvalidSymbolPatternIndicator-ForDCIFormat0_2 indicates 1, the UE may apply an invalid symbol pattern. If a higher layer parameter is configured, and if parameter InvalidSymbolPatternIndicator-ForDCIFormat0_1 or InvalidSymbolPatternIndicator-ForDCIFormat0_2 indicates 0, the UE may not apply an invalid symbol pattern. Alternatively, if a higher layer parameter (for example, InvalidSymbolPattern) is configured, and if parameter InvalidSymbolPatternIndicator-ForDCIFormat0_1 or InvalidSymbolPatternIndicator-ForDCIFormat0_2 is not configured, the UE may apply an invalid symbol pattern.

After an invalid symbol is determined in each nominal repetition, the UE may consider that symbols other than the determined invalid symbol are valid symbols. If each nominal repetition includes one or more valid symbols, the nominal repetition may include one or more actual repetitions. As used herein, the actual repetition may refer to a symbol actually used for PUSCH repeated transmission among symbols configured by the configured nominal repetition, and may include a set of consecutive valid symbols that may be used for PUSCH repeated transmission type B in one slot. Except for the case in which the configured PUSCH's symbol length L=1, the UE may omit actual repetition transmission in case that an actual repetition having one symbol is configured to be valid. By using [Table 8] below, a redundancy version may be applied according to the redundancy version pattern configured for each n^{th} actual repetition.

### TB Processing Over Multiple Slots (TBoMS)

As described above, the PUSCH's starting symbol and length may be determined by the TDRA method in one slot, and the gNB may transmit the number of repeated transmissions to the UE through higher layer signaling (for example, RRC signaling) or L1 signaling (for example, DCI). In an embodiment, the TBS may be determined by using the value of N (1 or larger) which is the number of slots configured by memberOfSlotsTBoMS.

The UE may transmit a PUSCH having the same starting symbol and length as the configured PUSCH, based on the number of slots for determining the TBS and the number of repeated transmissions received from the gNB, in consecutive slots. In an embodiment, in case that at least one of symbols in a slot configured as the downlink for the UE by the gNB, or in a slot for PUSCH repeated transmission configured for the UE, is configured as the downlink, the UE may omit PUSCH transmission in the corresponding slot. For example, even if a PUSCH is included in the number of PUSCH repeated transmissions, the UE may not transmit the same.

On the other hand, a UE that supports Rel-17 uplink data repeated transmission may determine that a slot in which uplink data repeated transmission is possible is an available slot, and may count the number of transmissions during PUSCH repeated transmission with regard to the slot deemed to be an available slot. In case that repeated transmission of the PUSCH in the slot deemed to be an available slot is omitted, repeated transmission may be performed through a slot in which transmission is possible after postponement. By using [Table 12] below, a redundancy version may be applied according to the redundancy version pattern configured for each n^{th} PUSCH transmission occasion.

TABLE 12

| rv_{id} indicated | rv_{id} to be applied to n^{th} transmission occasion (repetition Type A) or TB | | | |
|---|---|---|---|---|
| by the DCI | processing over multiple slots) or n^{th} actual repetition (repetition Type B) | | | |
| scheduling | ((n − (n mod N))/N) | ((n − (n mod N))/N) | ((n − (n mod N))/N) | ((n − (n mod N))/N) |
| the PUSCH | mod 4 = 0 | mod 4 = 0 | mod 4 = 0 | mod 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Hereinafter, a method for determining an uplink available slot for single-or multi-PUSCH transmission in a 5G system will be described.

According to an embodiment of the disclosure, if the UE has Available SlotCounting configured to be “enable,” the UE may determine an available slot, based on tdd-UL-DL-ConfigurationCommon, tdd-UL-DL-ConfigurationDedicated, ssb-PositionsInBurst, and time domain resource allocation (TDRA) information field value, for the sake of type A PUSCH repeated transmission and TBoMS PUSCH transmission. That is, in case that at least one symbol configured by TDRA for the PUSCH in a slot for PUSCH transmission overlaps at least one symbol having a purpose other than uplink transmission, the slot may be deemed to be an unavailable slot.

Hereinafter, a method for reducing the SSB density through dynamic signaling for gNB energy saving in a 5G system will be described.

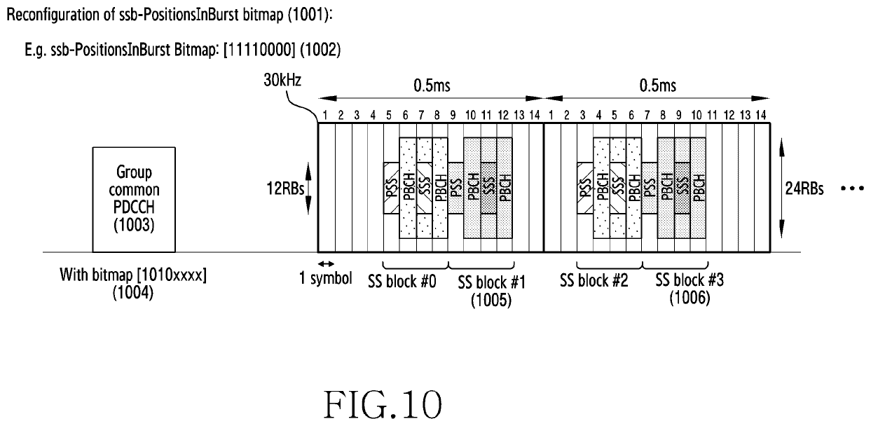

FIG. 10 illustrates an example of a method for reconfiguring SSB transmission through dynamic signaling of a wireless communication system according to an embodiment of the disclosure.

Referring to FIG. 10, the UE may have ssb-PositionsInBurst= “11110000” 1002 configured by the gNB through higher layer signaling (SIB1 or ServingCellConfigCommon). A maximum of two synchronization signal blocks may be transmitted within a time of 0.5 ms (or corresponding to the length of one slot in case that one slot is configured by 14 OFDM symbols) at a subcarrier spacing of 30 kHz. Accordingly, the UE may receive four synchronization signal blocks (SSBs) within a time of 1 ms (or corresponding to the length of two slots in case that one slot is configured by 14 OFDM symbols). The gNB may reconfigure SSB transmission configuration information by broadcasting bitmap “1010xxxx” 1004 through group/cell common DCI 1003 having a network energy saving-radio network temporary identifier (nwes-RNTI) (or es-RNTI) in order to reduce the density of SSB transmission for the sake of energy saving. Based on the bitmap 1004 configured through the group/cell common DCI, transmission of SS block #1 1005 and SSblock #3 1006 may be canceled. FIG. 10 illustrates a method 1001 for reconfiguring SSB transmission through bitmap-based group/cell common DCI.

In addition, the gNB may reconfigure ssb-periodicity configured through higher layer signaling through group/cell common DCI. In addition, timer information for indicating the timepoint to apply group/cell common DCI may be additionally configured such that an SSB is transmitted through SSB transmission information reconfigured by group/cell common DCI during the configured timer. Thereafter, if the timer expires, the gNB may operate by existing SSB transmission information configured by higher layer signaling. This changes configurations from a normal mode to an energy saving mode through the timer, and SSB configuration may be reconfigured accordingly. In another method, the gNB may configure the timepoint to apply SSB configuration information reconfigured through group/cell common DCI and the duration thereof for the UE as offset and duration information. The UE may not monitor SSBs for the duration from the timepoint at which the offset is applied, since the moment at which group/cell common DCI is received.

Hereinafter, a method for BWP or BW adaptation through dynamic signaling for gNB energy saving in a 5G system will be described.

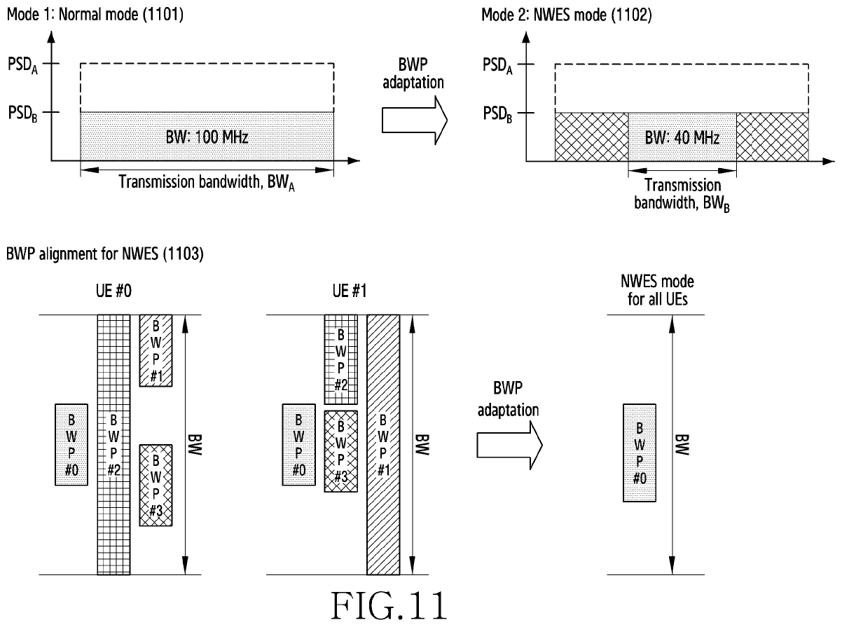

FIG. 11 illustrates an example of a method for reconfiguring a BWP and a BW through dynamic signaling of a wireless communication system according to an embodiment of the disclosure.

Referring to FIG. 11, the UE may operate with a BWP or BW activated through higher layer signaling and L1 signaling from the gNB (1101). For example, the UE may operate through a full BW of 100 MHz with fixed power spectral density (PSD) B. The gNB may adjust the BW and BWP such that a narrower BW of 40 MHz is activated to the UE while having the same PSDB for energy saving (1102). The BW or BWP adjusting operation for the gNB's energy saving may be configured to equally align the BWP and BW configurations that have been UE-specifically configured through group-common DCI and cell-specific DCI (1103). For example, UE #0 and UE #1 may have different BWP configurations and positions. In order to save energy by reducing the BW used by the gNB, all UE's BW and BWP may have one identical configuration. One or more BWPs or BWs may be configured in the energy saving operation, and this may be used to configure a UE group-specific BWP.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and/or
Uplink control information (UCI).

Hereinafter, the above examples may be described through several embodiments, but they are not independent of each other, and one or more embodiments may be applied simultaneously or in combination.

Hereinafter, a method for DRX alignment through dynamic signaling for gNB energy saving in a 5G system will be described.

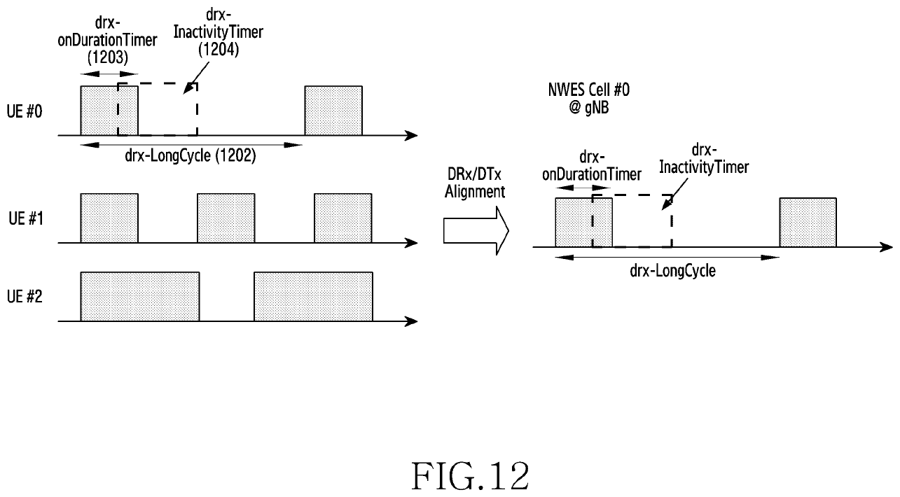

FIG. 12 illustrates an example of a method for reconfiguring DRX through dynamic signaling of a wireless communication system according to an embodiment of the disclosure.

Referring to FIG. 12, the gNB may configure DRX UE-specifically through higher layer signaling. For example, each UE may have different drx-LongCycle 1202 or drx-ShortCycle/drx-onDurationTimer 1203 and drx-InactivityTimer 1204 configured therefor. Thereafter, the gNB may configure a UE-specific DRX configuration for energy saving in a UE group specific or cell specific manner through L1 signaling (1201). This may ensure that the gNB obtains the same energy saving effect as the UE's power saving through DRX.

Hereinafter, an example of discontinuous transmission (DTx) operation for reducing energy consumed by a gNB in a 5G system will be described.

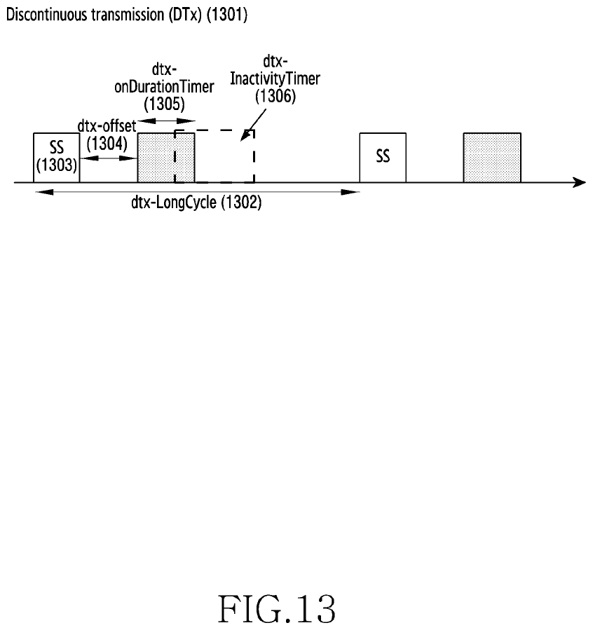

FIG. 13 illustrates an example of a DTx method for gNB energy saving according to an embodiment of the disclosure.

Referring to FIG. 13, the gNB may configure DTx for energy saving through higher layer signaling (e.g., new system information block (SIB) for DTx or RRC signaling) and L1 signaling (e.g., DCI). The gNB may receive dtx-onDurationTimer 1305 for transmitting a PDCCH for scheduling a DL SCH for a DTx operation or a reference signal for RRM measurement, beam management, and pathloss measurement, a DL SCH, and a scheduling PDCCH. The gNB may then configure dtx-InactivityTimer 1306 for receiving a PDSCH, synchronization signal (SS) 1303 configuration information for synchronization prior to dtx-onDurationTimer, dtx-offset 1304 for configuring the offset between the SS and dtx-onDurationTimer, and dtx-(Long) Cycle 1302 for periodic operatic operation of DTx based on configuration information. Multiple dtx-cycles, including long and short cycles, may be configured. During the DTx operation, the gNB may consider that the transmitting end is in an off (or inactive) state and may thus not transmit the DL CCH, SCH, and DL RS. That is, the gNB may transmit only the SS during the DTx operation, and may transmit the downlink (e.g., PDCCH, PDSCH, RS, and the like) during dtx-onDuration Timer and dtx-InactivityTimer only. As additional information of the configured SS, SS-gapbetweenBurst (the gap between SS bursts in the time domain) or the number of SS bursts may be additionally configured.

Hereinafter, a method for gNB activation through a gNB wake-up signal (WUS) during a gNB inactive mode for reducing energy consumed by the gNB in a 5G system will be described.

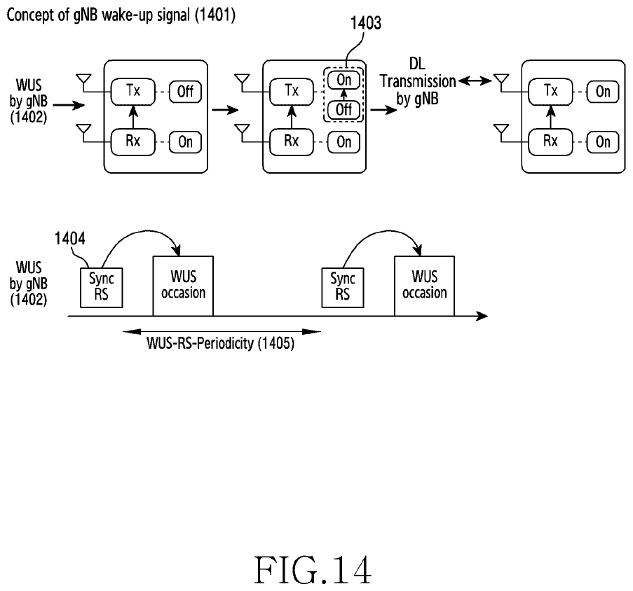

FIG. 14 illustrates an example of operations of a gNB according to a gNB WUS according to an embodiment of the disclosure.

Referring to FIG. 14, the gNB may maintain the transmitter end in an off (or inactive) state during the gNB's inactive state (or sleep mode) for the sake of energy saving. Thereafter, the gNB may receive a gNB WUS 1402 for activating the gNB's sleep mode from the UE. Thereafter, the gNB may change the Tx end to an on (or active) state upon receiving a WUS from the UE through the Rx end (1403). Thereafter, the gNB may perform downlink transmission to the UE. The gNB may perform synchronization after Tx on and may perform control and data transmission. In addition, various uplink signals, such as PRACH, scheduling request (SR PUCCH), PUCCH including Ack, and the like may be considered as the gNB WUS. Through the above method, the gNB may save energy, and the UE may simultaneously improve latency.

The gNB may configure a WUS occasion for receiving a gNB WUS, and a sync RS for synchronization before the UE transmits the gNB WUS. As the sync RS, an SSB, a TRS, a light SSB (PSS+SSS), consecutive SSBs or new RS (continuous PSS+SSS) may be considered, and as the WUS, a PRACH, a PUCCH with SR, or a sequence-based signal may be considered. A sync RS 1404 used by the UE to activate an inactive mode for the gNB's energy saving, and a WUS occasion for receiving a WUS may be repeatedly transmitted with WUS-RS periodicity 1405. Although an embodiment is described in FIG. 14 with regard to 1-to-1 mapping between the sync RS and WUS occasion as an example, the disclosure is not limited thereto. For example, the sync RS and WUS occasion may have N-to-1 mapping, 1-to-N mapping, or N-to-M mapping.

Hereinafter, a method for dynamically turning on/off the gNB's spatial domain element (that is, antenna, power amplifier (PA) or transceiver units or transmission radio units (TxRUs)) for gNB energy saving in a 5G system will be described.

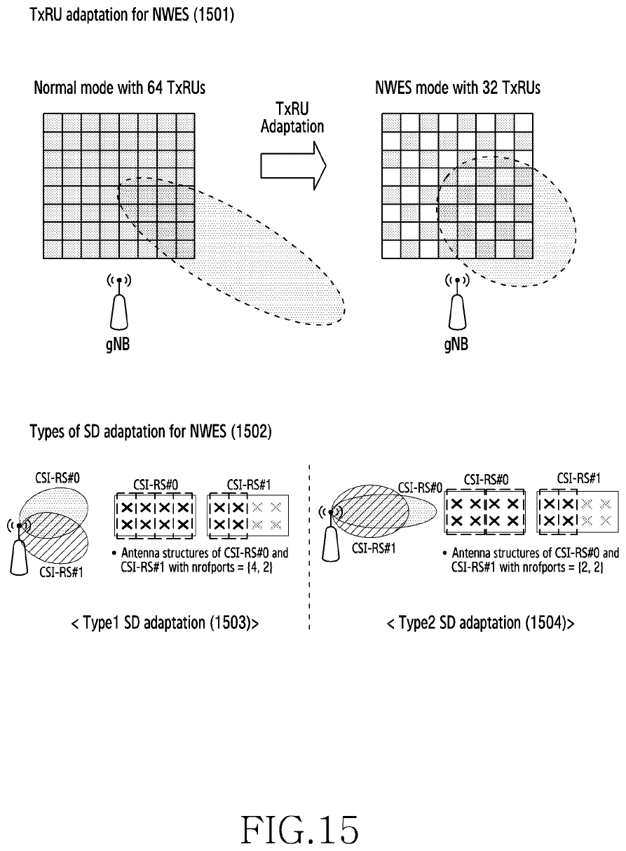

FIG. 15 illustrates an example of a gNB's antenna adaptation method for energy saving of a wireless communication system according to an embodiment of the disclosure.

Referring to FIG. 15, the gNB may adjust the Tx antenna port per radio unit (RU) for network energy savings (NWES) (1501). For example, the gNB's PA occupies the majority of energy consumed by the gNB, and the gNB may thus turn off the Tx antenna to save energy. In order to determine whether the Tx antenna can be turned off, the gNB may reference/use the UE's reference signal received power (RSRP), channel quality indicator (CQI), reference signal received quality (RSRQ), and the like. The gNB may perform TX transmission by adjusting the number of activated Tx antennas with regard to each UE group or each UE. The gNB may configure, for the UE, information including at least one from among beam information based on antenna on/off or reference signal information (for example, at least one of a CSI resource, a CSI resource set, or a CSI report) through higher layer signaling (for example, RRC signaling) or DCI signaling. In addition, the gNB may configure different antenna information for each BWP, thereby reconfiguring antenna information according to a BWP change. In addition, the gNB may receive CSI feedback from the UE in order to determine whether spatial domain (SD) adaptation is possible or not. The gNB may determine SD adaptation (based on the CSI feedback). The gNB may receive multiple pieces of feedback from the UE through antenna structure hypotheses of various antenna patterns for SD adaptation.

More specifically, the gNB may apply multiple (for example, two) types of SD adaptation for energy saving (1502). For example, the multiple types may include type 1 SD adaptation 1503 and type 2 SD adaptation 1504.

If type 1 SD adaptation 1503 is applied, the gNB may adapt the number of antenna ports while maintaining the number of physical antenna ports per antenna port (that is, logical port). The RF characteristics (e.g., tx power, beam) per port may be identical. Therefore, the UE sum up the CSI-Rs of the same port during CSI measurement (e.g., layer 1-RSRP (L1-RSRP), layer 3-RSRP (L3-RSRP), or the like) and perform measurement.

In another method, if type 2 SD adaptation 1504 is applied, the gNB may turn on/off physical antenna elements per port with the same number of antenna ports (that is, logical ports) (1504). The RF characteristics per port may vary. The UE may distinguish the same port's CSI-RS during CSI measurement and perform each measurement. The gNB may save energy through at least one of multiple types of SD adaptation methods, including the two types of SD adaptation described above.

Hereinafter, a method for configuring an on-demand SSB and SIB1 for applying an on-demand SSB and SIB1 for a gNB's energy saving in a 5G system will be described. As used herein, “on-demand operation” may include an on-demand SSB and an on-demand SIB (on-demand SIB1). In addition, although an embodiment will now be described with reference to the on-demand SSB, the same is obviously applicable to the on-demand SIB (on-demand SIB1).

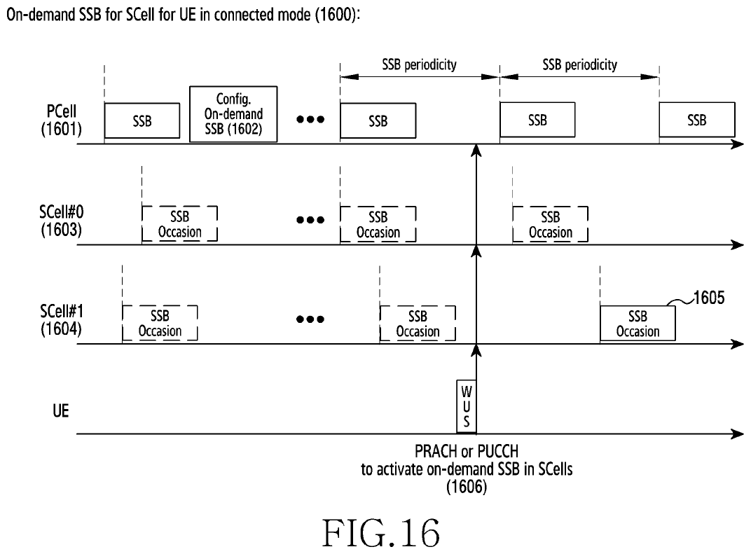

FIG. 16 illustrates an example of on-demand SSB operations of a gNB and a UE according to an embodiment of the disclosure.

Referring to FIG. 16, the gNB may apply an on-demand SSB operation to one or multiple SCells during a CA operation. More specifically, the gNB may perform periodic SSB transmission in the PCell 1601. The gNB may give the UE on-demand SSB configurations regarding SCells through higher layer signaling and/or L1 signaling. For example, the gNB may give the UE on-demand SSB configurations in the Pcell through RRC signaling 1602. Thereafter, the UE may transmit an uplink signal (for example, a PUCCH or PRACH) 1606 as a WUS, based on the configured information, thereby triggering SSB transmission of an SCell (e.g., SCell #1) 1604. The gNB may transmit an SSB burst 1605 after receiving the WUS.

A method for configuring the on-demand SSB and SCell for the above operation may be configured as one of the following methods or a combination thereof, and SCell activation/deactivation may also be determined.

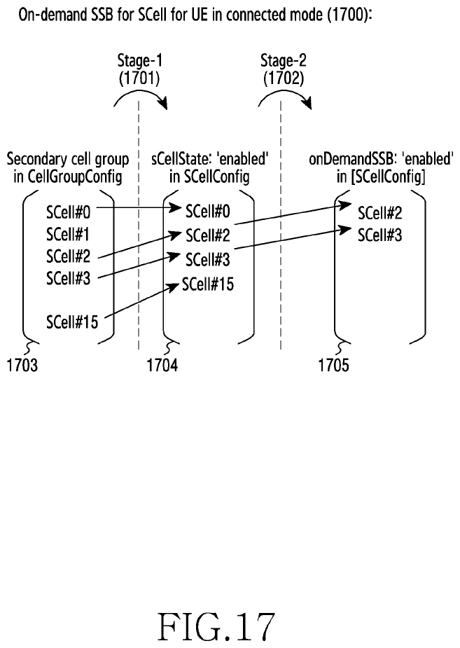

FIG. 17 illustrates an example of a method for configuring SCell activation/deactivation and on-demand SSB by a gNB according to an embodiment of the disclosure.

Referring to FIG. 17, the gNB may configure (e.g., CellgroupConfig) a secondary cell group including candidate SCells through higher layer signaling (for example, RRC signaling) (1703). Thereafter, the gNB may indicate an SCell to be activated with regard to each UE, thereby activating or deactivating the SCell (1704). More specifically, the gNB may configure sCellState of SCellConfig (RRC signaling) to be “enable,” or may activate or deactivate one or more SCells through MAC CE signaling. Thereafter, the gNB may configure an on-demand operation with regard to the activated SCells through at least one of RRC signaling, MAC CE signaling, and L1 signaling (1705). The on-demand operation configuration may be configured in the process of activating SCells in stage-1 1701 or may be applied together with SCell activation. Alternatively, the on-demand operation configuration may be applied only in stage-2 1702, and the on-demand operation may then be configured through sCell-config regarding activated SCells or MAC CE or L1 signaling (for example, group common DCI). In addition, the on-demand operation may be activated or deactivated concurrently with SCell activation.

Through the above methods, the gNB may configure and indicate SCell activation/deactivation and/or on-demand operations to the UE. Thereafter, the UE may determine SSB reception and WUS transmission according to whether the on-demand operation is activated in SCells or not, based on configuration information.

Hereinafter, methods for SCell activation/deactivation configurations and/or on-demand configurations of the disclosure will be provided. The gNB may configure on-demand operations including SCell activation/deactivation for the UE, based on one of the following methods or a combination thereof.

### [Configuration 1]

In configuration 1 according to an embodiment, the gNB may configure whether or not to activate on-demand operations, and configuration information regarding on-demand operations in SCells through RRC signaling for energy saving.

The gNB may configure, for the UE, whether to activate or deactivate SCells and/or whether to activate or deactivate an on-demand SSB or SIB1 operation through RRC signaling.

For example, whether or not to activate an on-demand operation may be configured by RRC signaling in sCellConfig as in [Table 13] below:

TABLE 13
sCellConfig ::= SEQUENCE {
sCellIndex SCellIndex,
sCellConfigCommon ServingCellConfigCommon OPTIONAL, -- Cond SCellAdd
sCellConfigDedicated ServingCellConfig OPTIONAL, -- Cond SCellAddMod
...,
[[
smtc SSB-MTC OPTIONAL -- Need S
]],
[[
sCellState-r16 ENUMERATED {activated} OPTIONAL, -- Cond SCellAddSync
onDemandSSB-r18 ENUMERATED {activated} OPTIONAL
onDemandSIB-r18 ENUMERATED {activated} OPTIONAL
onDemand-r18 ENUMERATED {Disable, SSB, SIB, Both} OPTIONAL
secondaryDRX-GroupConfig-r16 ENUMERATED {true} OPTIONAL -- Need S
]],
[[
preConfGapStatus-r17 BIT STRING (SIZE (maxNrofGapId-r17)) OPTIONAL, -- Cond
PreConfigMG
goodServingCellEvaluationBFD-r17 GoodServingCellEvaluation-r17
OPTIONAL, -- Need R
sCellSIB20-r17 SetupRelease { SCellSIB20-r17 } OPTIONAL -- Need M
]],
[[
plmn-IdentityInfoList-r17 SetupRelease {PLMN-IdentityInfoList}
OPTIONAL, -- Cond
SCellSIB20-Opt
npn-IdentityInfoList-r17 SetupRelease {NPN-IdentityInfoList-r16}
OPTIONAL -- Cond
SCellSIB20-Opt
]]
}

Referring to [Table 13], the gNB may configure an on-demand operation for the gNB's energy saving through the sCellConfig RRC configuration by using RRC signaling such as onDemandSSB-r18 or onDemandSIB-r18 or onDemand-r18, thereby indicating whether or not to perform an on-demand operation in the SCell corresponding to sCellIndex. The above example corresponds to an embodiment of the disclosure, and the on-demand operation for the gNB's energy saving may be configured to be included in sCellConfigCommon or sCellConfigDedicated, besides the sCellConfig 1E.

In addition, configuration information (for example, periodicity, pattern, the number of SSBs) used when the gNB or UE activates an on-demand SSB or SIB and starts transmission may be configured through individual RRC signaling. Additionally, in the case of an SSB, the list of specific patterns may be configured through RRC signaling, and the pattern index of the list may be indicated/configured through a MAC-CE or DCI such that an SSB pattern is configured for each SCell. The multi-pattern configuration method may also be applied to other channel's on-demand operation, such as SIB1. In the case of on-demand operation configuration, the same may operate together with or independently of SCell activation/deactivation information. For example, the on-demand operation configuration may be applied with regard to an SCell, the sCellState of which is configured to be “activated.” On the other hand, the on-demand operation may be individually configured regardless of whether the SCell is activated or not, and the SCell activation operation may be performed together in case that the gNB activates the SCell, or the UE activates a deactivated SCell's on-demand operation through WUS transmission. In addition, WUS transmission-related configuration information for requesting the UE's on-demand operation and WUS pattern information may be configured for the UE through RRC signaling.

### [Configuration 2]

In configuration 2 according to an embodiment, the gNB may configure whether or not to activate on-demand operations in one or more SCells through RRC signaling for energy saving. In addition, the gNB may indicate a pattern regarding on-demand operations in SCells to the UE.

The gNB may configure individually or together, for the UE, whether to activate or deactivate SCells and/or whether to activate or deactivate an on-demand SSB or SIB1 operation through a MAC-CE.

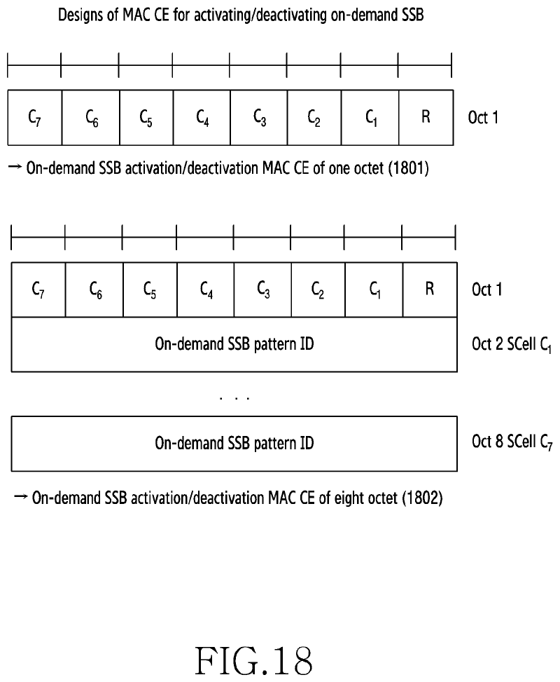

FIG. 18 illustrates an example of a method for configuring SCell activation/deactivation and on-demand SSB, based on a MAC-CE, by a gNB according to an embodiment of the disclosure.

Referring to FIG. 18, the gNB may indicate on-demand SSB operation activation/deactivation and/or an on-demand SSB pattern with regard to one or multiple SCells through MAC CE signaling. For example, the gNB may indicate on-demand SSB operation activation/deactivation with regard to SCells C₁-C₇ through a MAC CE having one octet (1801). C; may correspond to the index of a candidate SCell configured by RRC. As an example, the same may correspond in ascending order of i, from the lowest SCell index to higher ones. Whether or not to activate the on-demand operation and/or whether to activate or deactivate SCells may be indicated together through the MAC CE. In other words, the UE may determine that an SCell having an activated on-demand SSB operation is an activated SCell. The on-demand SSB pattern may be predefined between the UE and the gNB or may be configured for the UE through separate information. As another example, the gNB may indicate on-demand SSB operation activation with regard to SCells C₁-C₇ through a MAC CE having multiple octets, and may indicate an on-demand SSB pattern regarding each SCell (1802). The gNB may select an on-demand SSB pattern by selecting the pattern index from the pattern list configured through RRC signaling. In this case, whether or not to activate the on-demand SSB operation and/or whether to activate or deactivate SCells may be indicated together through the MAC CE.

### [Configuration 3]

In configuration 3 according to an embodiment, the gNB may configure whether or not to activate on-demand operations in one or more SCells through DCI for energy saving. In addition, the gNB may indicate an on-demand transmission pattern regarding on-demand operations in SCells.

The gNB may configure individually or together, for the UE, whether to activate or deactivate SCells and/or whether to activate or deactivate an on-demand SSB or SIB1 operation through DCI. The DCI may be cell-specific DCI, and group common DCI or UE-specific DCI may be applied.

For example, a group common DCI format as in [Table 14] may be configured in consideration of one or multiple SCells.

TABLE 14
DCI format 2_X is used for notifying on-demand SSB on one or more the
activated SCell by RRC and MAC CE.
The following information is transmitted by means of the DCI format
2_X with CRC scrambled by Ondemad-RNTI:
- block number 1, block number 2,..., block number N
where the starting position of a block is determined in order of SCellIndex
The following fields defined for the block:
- On-demand SSB indication - 1 bit
- On-demand pattern indication - N bit if higher layer parameter
onDemandpatternList is configured
- WUS occasion indication - N bit if higher layer parameter
WUSResourceAllocationList is configured
The size of DCI format 2_X is determined by the number of activated
SCell.

Referring to [Table 14], DCI is configured by multiple blocks with regard to each SCell, and the number of blocks may be determined by the number of activated SCells or the number of candidate SCells belonging to the secondary cell group. In addition, the UE may determine the position of blocks (that is, the starting position of bits), based on information configured through higher layer signaling (for example, RRC signaling), with regard to each SCell, or may determine the position of blocks, based on the SCell index. For example, if the configured SCell index is {1,2,3,7}, allocating the same to block1-block4, starting from a small SCell index, may be considered. Each block may include a bit indicating whether or not to activate an on-demand operation in the corresponding SCell. For example, two bits may be used in consideration of the on-demand SSB and SIB such that “00” means “deactivated,” “01” means on-demand SSB activation, “10” means on-demand SIB1 activation, and “11” means on-demand SSB & SIB1 activation. In addition, each block may include a bit indicating WUS configuration information and on-demand pattern information after the bit that indicates activation information. The DCI format's configuration may be combined with RRC signaling and MAC CE signaling and used together. In addition, the configuration of blocks is only an embodiment, and does not limit the scope of the disclosure.

Through embodiments of the disclosure, the gNB may configure and activate on-demand operations, and may also indicate whether to activate or deactivate SCells. In addition, the signaling's value is an example, and may be variously configured.

Through the above-described methods or embodiments, the gNB's energy consumption may be reduced. In addition, above methods or embodiments may be configured simultaneously through a combination of one or more thereof.

Through methods according to an embodiment of the disclosure, the gNB's energy consumption may be reduced. In addition, methods according to an embodiment of the disclosure may be configured/used as one or may be configured/used simultaneously through a combination of more than one.

According to an embodiment of the disclosure, the gNB may transmit signals and channels that are always transmitted periodically only when necessary, in order to reduce energy consumption. More specifically, the gNB may transmit signals (for example, SSB or SIB1) that are always transmitted periodically according to the UE's uplink signal and the gNB's determination. The gNB may configure configuration information regarding the operation for the UE through higher layer signaling and/or L1 signaling. In addition, the UE's operations may be defined according to the above configuration. In the disclosure, terms “energy saving,” “energy consumption reduction,” and “decreasing energy consumption” may be used interchangeably and understood in the same sense. Unless specifically mentioned otherwise, operations of SIBs other than the SSB and SIB1 may be included in the disclosure.

According to an embodiment of the disclosure, the UE's operation during an on-demand operation in an SCell for gNB energy saving is provided. More specifically, the gNB may configure SCell group configuration information for CA operations, SCell activation/deactivation configuration information, and/or on-demand operation configuration information for the UE through higher layer signaling and/or L1 signaling. Operations of the UE that has received the configuration information may be defined. Accordingly, the UE may perform no unnecessary operations during the gNB's energy saving operation, thereby saving energy.

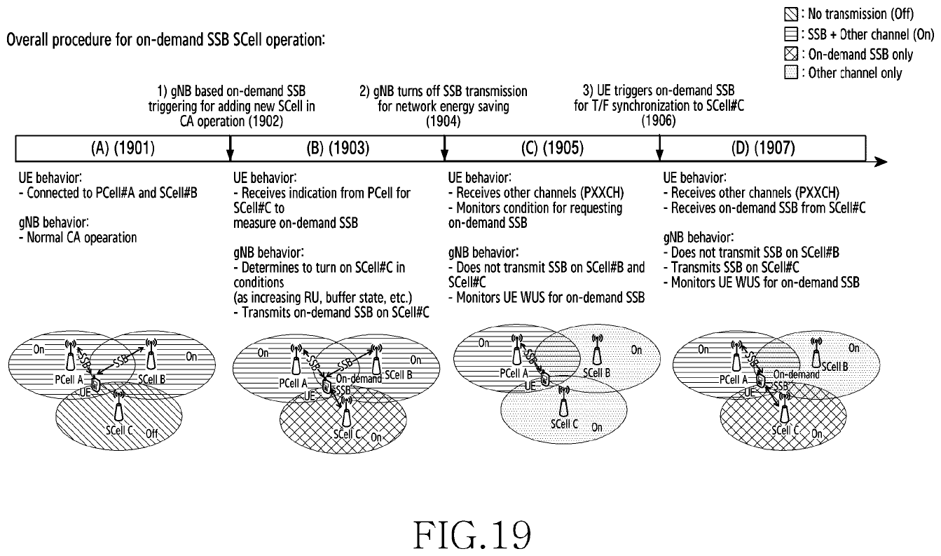

FIG. 19 illustrates examples of operations of a gNB and a UE according to an on-demand SSB SCell for the gNB's energy saving according to an embodiment of the disclosure.

Referring to FIG. 19, the gNB may perform a CA operation by using PCell #A and SCell #B. The gNB may determine candidate SCells applicable to the UE in consideration of the channel state and the like with the SCell with regard to each UE, and may configure the same for the UE through higher layer signaling (for example, RRC signaling). During the CA operation, the UE may perform measurement and/or post-connected operations with regard to PCell #A and SCell #B (A, 1901). The UE's measurement operation is applicable to SCells that transmit an SSB. Thereafter, the gNB may activate SCell #C that has been turned off to save the gNB's energy through inter-gNB backhaul signaling in consideration of the traffic state and the gNB's buffer state, the channel state between the UE and SCells, and/or the UE's mobility. The gNB may indicate, to the UE, that a new SCell's on-demand SSB may be transmitted in SCell #C, through higher layer signaling and L1 signaling (1902). The signaling may be configured through the PCell. Upon receiving the configuration information, the UE may receive an on-demand SSB from SCell #C and may perform reporting or initial accessing after measurement (B, 1903). Thereafter, the gNB may deactivate SSB transmission of SCell #B and SCell #C, which are periodically repeated, in order to save the gNB's energy, and may perform the same as needed, thereby performing an on-demand SSB operation. The gNB may indicate the on-demand SSB operation to the UE through higher layer signaling (for example, RRC signaling or MAC CE signaling) and/or L1 signaling (for example, group common DCI). The gNB considers the situation in which the channel state between the UE and SCell is stable, or the UE's mobility is at a low level, and also considered that time/frequency synchronization is maintained between the UE and SCell. The UE may perform no SSB monitoring with regard to SCells for which an on-demand SSB operation is configured. On the other hand, a different CSI-RS (or tracking reference signal (TRS)), PDSCH, PDCCH, PUSCH, PUCCH, or the like may be transmitted/received. In addition, by monitoring the false alarm probability, frequency offset, or SINR variation between symbols or subcarriers of the channels, excluding SSBs by implementation, or the quasi-colocation (QCL) performance of the downlink's DMRS and RS, the time/frequency synchronization performance with SCells may be monitored and evaluated. The gNB may perform WUS monitoring in order to receive an on-demand SSB request from the UE (C, 1905). Thereafter, the UE may determine that time/frequency synchronization with a specific SCell has failed, and may trigger SSB transmission in the corresponding SCell through the uplink channel (for example, PRACH, PUCCH or PUSCH). Thereafter, the UE may determine whether an on-demand SSB is received from the gNB and may receive the on-demand SSB and may perform CSI reporting after measurement. The gNB may continuously monitor the WUS in order to receive an additional SSB request or the like from the UE. On the other hand, the gNB may receive no WUS during on-demand SSB transmission. The UE may be configured regarding whether the gNB monitors the WUS (D, 1907).

Through the procedures of the gNB and the UE, on-demand SSB operations for the gNB's energy saving may be supported. Accordingly, the gNB and the UE may efficiently manage energy.

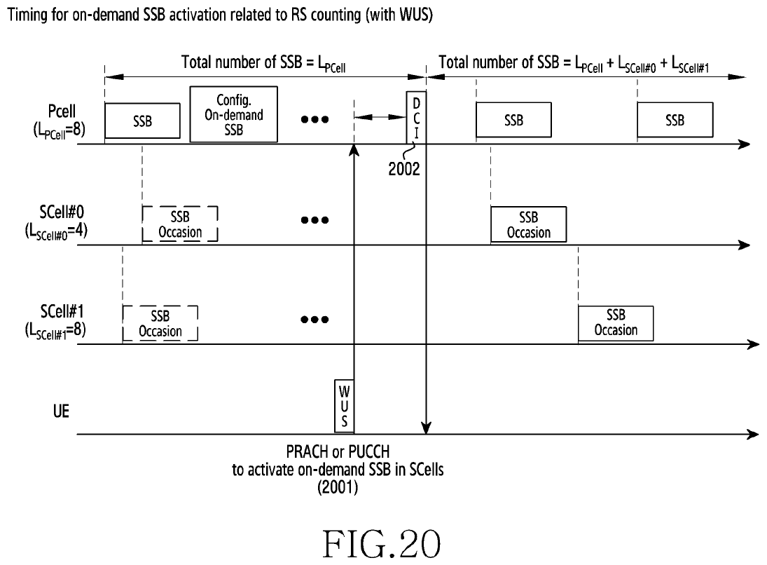

FIG. 20 illustrates an example of an on-demand SSB activation time for energy saving of a wireless communication system according to an embodiment of the disclosure.

Referring to FIG. 20, the UE may have an on-demand SSB operation configured in an SCell by the gNB through higher layer signaling and L1 signaling. Thereafter, in case that no SSB is transmitted during the on-demand SSB operation in the corresponding SCell, based on configuration information, the UE does not measure and store SSBs. Thereafter, in case that the UE determines that time/frequency re-synchronization through SSBs is necessary, the UE may transmit wake-up-signaling (for example, PRACH or PUCCH) to the PCell (2001). The WUS may be transmitted to the PCell or SCell according to the configuration. Thereafter, in response to the WUS, the gNB may configure whether or not to start on-demand SSB transmission through a PDCCH or PDSCH (2002). Thereafter, the UE may measure an SSB in consideration of on-demand SSB transmission in the corresponding SCell, based on configuration information, may allocate a memory, and may store the same. Therefore, the on-demand SSB's activation time may be defined as spanning from the last symbol of a PDCCH or PDSCH received from the gNB after the UE's WUS transmission to the timepoint at which the on-demand SSB transmission ends. The timepoint at which the on-demand SSB transmission ends may be applied as the timepoint at which the on-demand SSB's configuration information (timer) expires, the timepoint at which a designated duration ends, the timepoint at which the on-demand SSB transmission is canceled by higher layer signaling and L1 signaling from the gNB, or the timepoint at which the SCell is deactivated. More specifically, the UE may measure and store as many SSBs as L_{PCell} transmitted from the PCell before receiving a PDCCH that indicates on-demand SSB transmission from the gNB. On the other hand, after receiving the PDCCH, the UE may measure and store as many SSBs as a total of L_{PCell}+L_{SCell#0}+L_{SCell#1} in consideration of SSBs of both the PCell and SCell. The number of RSs may be counted according to the on-demand SSB activation time, and the UE's memory may be allocated and used in proportion to the count. The total number of RSs of a total of one Cell or all Cells is determined as the UE's capability, and cannot be configured or activated beyond the value. In case that an SCell is activated to such an extent that the total number of RSs exceeds the UE's capability, SSBs having a low SCell index and a low SSB index may be stored first. The above method is an embodiment of the disclosure, and the disclosure may be implemented in a UE in various methods. Through the above embodiment, the on-demand SSB activation time after WUS transmission during an on-demand SSB operation for the gNB's energy saving, and after a downlink indication from the gNB, may be determined. This may be used to determine a CSI processing unit (CPU) for RS counting and CSI reporting.

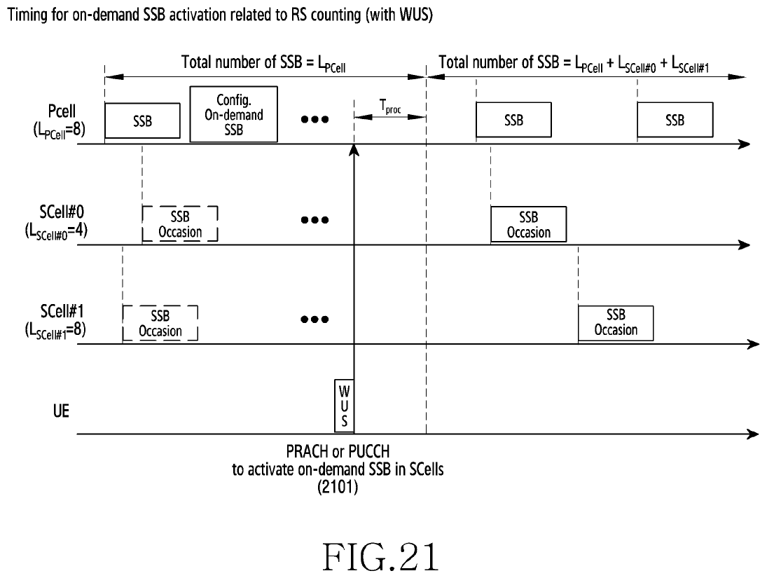

FIG. 21 illustrates an example of an on-demand SSB activation time for energy saving of a wireless communication system according to an embodiment of the disclosure.

Referring to FIG. 21, the UE may have an on-demand SSB operation configured in an SCell by the gNB through higher layer signaling and L1 signaling. Thereafter, in case that no SSB is transmitted during the on-demand SSB operation in the corresponding SCell, based on configuration information, the UE may not measure and store SSBs. Thereafter, in case that the UE determines that time/frequency re-synchronization through SSBs is necessary, the UE may transmit wake-up-signaling (for example, PRACH or PUCCH) to the PCell (2101). The WUS may be transmitted to the PCell or SCell according to the configuration. Thereafter, the UE may start SSB monitoring, based on SSB configuration information configured for the corresponding SCell through higher layer signaling and L1 signaling. More specifically, the UE may measure an SSB in consideration of on-demand SSB transmission in the corresponding SCell, based on configuration information, may allocate a memory, and may store the same. Therefore, the on-demand SSB's activation time may be defined as spanning from the earliest symbol or slot after Tproc after the UE's WUS transmission to the timepoint at which the on-demand SSB transmission ends. The Tproc may be configured through higher layer signaling and L1 signaling from the gNB. The timepoint at which the on-demand SSB transmission ends may be applied as the timepoint at which the on-demand SSB's configuration information (timer) expires, the timepoint at which a designated duration ends, the timepoint at which the on-demand SSB transmission is canceled by higher layer signaling and L1 signaling from the gNB, or the timepoint at which the SCell is deactivated. More specifically, the UE may measure and store as many SSBs as LPCell transmitted from the PCell before Tproc since WUS transmission. On the other hand, after receiving the PDCCH, the UE may measure and store as many SSBs as a total of LPCell+LSCell #0+LSCell #1 in consideration of SSBs of both the PCell and SCell. The number of RSs may be counted according to the on-demand SSB activation time, and the UE's memory may be allocated and used in proportion to the count. The total number of RSs of a total of one Cell or all Cells is determined as the UE's capability, and cannot be configured or activated beyond the value. In case that an SCell is activated to such an extent that the total number of RSs exceeds the UE's capability, SSBs having a low SCell index and a low SSB index may be stored first. The above method is an embodiment of the disclosure, and the disclosure may be implemented in a UE in various methods. Through the above embodiment, the on-demand SSB activation time after WUS transmission during an on-demand SSB operation for the gNB's energy saving, may be determined. This may be used to determine a CSI processing unit (CPU) for RS counting and CSI reporting.

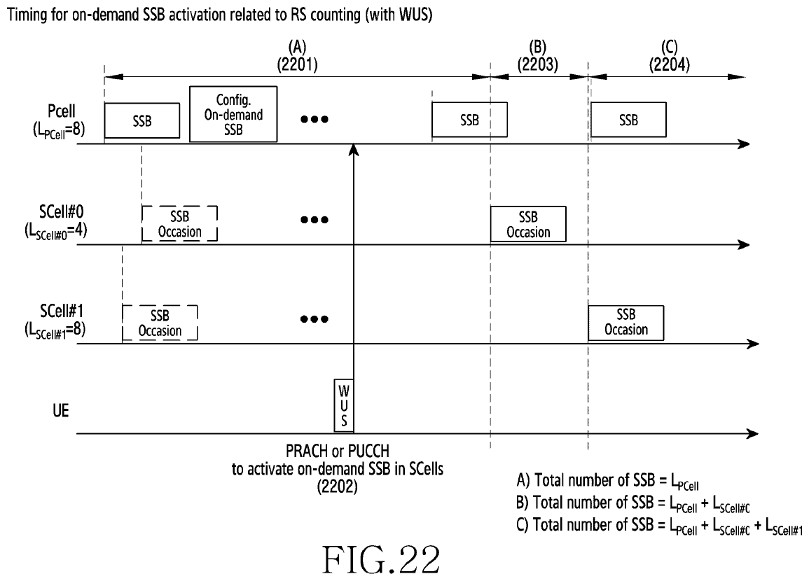

FIG. 22 illustrates an example of an on-demand SSB activation time for energy saving of a wireless communication system according to an embodiment of the disclosure.

Referring to FIG. 22, the UE may have an on-demand SSB operation configured in an SCell by the gNB through higher layer signaling and L1 signaling. Thereafter, in case that no SSB is transmitted during the on-demand SSB operation in the corresponding SCell, based on configuration information, the UE may not measure and store SSBs. Thereafter, in case that the UE determines that time/frequency re-synchronization through SSBs is necessary, the UE may transmit wake-up-signaling (for example, PRACH or PUCCH) to the PCell (2201). The WUS may be transmitted to the PCell or SCell according to the configuration. Thereafter, the UE may start SSB monitoring, based on SSB configuration information configured for the corresponding SCell through higher layer signaling and L1 signaling. More specifically, the UE may measure an SSB in consideration of on-demand SSB transmission in the corresponding SCell, based on configuration information, may allocate a memory, and may store the same. Therefore, the on-demand SSB's activation time may be defined as spanning from the timepoint at which the earliest SSB occasion starts after the UE's WUS transmission to the timepoint at which the on-demand SSB transmission ends. The timepoint at which the on-demand SSB transmission ends may be applied as the timepoint at which the on-demand SSB's configuration information (timer) expires, the timepoint at which a designated duration ends, the timepoint at which the on-demand SSB transmission is canceled by higher layer signaling and L1 signaling from the gNB, or the timepoint at which the SCell is deactivated. More specifically, the UE may consider, measure, and store as many SSBs as L_{PCell} in interval A 2201 prior to starting of the closest SSB occasion in the SCell after WUS transmission. Thereafter, if transmission of an on-demand SSB is triggered in SCell #0, as many SSBs as L_{PCell}+L_{SCell#0} may be considered, measured, and stored in the memory in interval B prior to coming of an SSB occasion, in different SCell #1, starting from symbols of the earliest SSB occasion. Thereafter, if transmission of an on-demand SSB is triggered in SCell #1, as many SSBs as L_{PCell}+L_{SCell#0}+L_{SCell#1} may be considered, measured, and stored in the memory in interval C 2204 after the earliest SSB occasion. The number of RSs may be counted according to the on-demand SSB activation time, and the UE's memory may be allocated and used in proportion to the count. The total number of RSs of a total of one Cell or all Cells is determined as the UE's capability, and cannot be configured or activated beyond the value. In case that an SCell is activated to such an extent that the total number of RSs exceeds the UE's capability, SSBs having a low SCell index and a low SSB index may be stored first. The above method is an embodiment of the disclosure, and the disclosure may be implemented in a UE in various methods. Through the above embodiment, the on-demand SSB activation time after WUS transmission during an on-demand SSB operation for the gNB's energy saving, may be determined. This may be used to determine a CSI processing unit (CPU) for RS counting and CSI reporting. In addition, the method in FIG. 22 may be defined to include the procedure of indication from the gNB through the downlink, or the processing time after WUS, in FIG. 20 of FIG. 21. Through the above method, an SSB occasion at which an on-demand SSB may actually go out may be used as the on-demand SSB activation time's starting point such that unnecessary UE memory allocation is avoided, and the UE's resource capability is used efficiently.

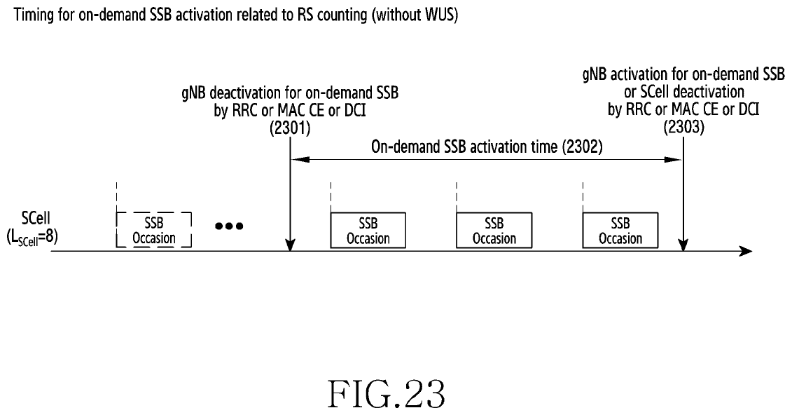

FIG. 23 illustrates an example of an on-demand SSB activation time for energy saving of a wireless communication system according to an embodiment of the disclosure.

Referring to FIG. 23, the UE may have an on-demand SSB operation configured in an SCell by the gNB through higher layer signaling and L1 signaling. Thereafter, in case that no SSB is transmitted during the on-demand SSB operation in the corresponding SCell, based on configuration information, the UE may not measure and store SSBs. Thereafter, the demand SSB operation is deactivated through higher layer signaling and L1 signaling from the gNB, and periodic SSB transmission may start in the corresponding SCell. The UE may start SSB monitoring, based on SSB configuration information configured for the corresponding SCell after receiving the corresponding signal. More specifically, the UE may measure an SSB in consideration of on-demand SSB transmission in the corresponding SCell, based on configuration information, may allocate a memory, and may store the same. Therefore, the on-demand SSB's activation time may be defined as spanning from the last symbol of the downlink signal 2301 that has indicated deactivation of the on-demand SSB operation and periodic SSB transmission from the gNB, to the timepoint 2303 at which the on-demand SSB operation is resumed (2302). The number of RSs may be counted according to the on-demand SSB activation time, and the UE's memory may be allocated and used in proportion to the count. The total number of RSs of a total of one Cell or all Cells is determined as the UE's capability, and cannot be configured or activated beyond the value. In case that an SCell is activated to such an extent that the total number of RSs exceeds the UE's capability, SSBs having a low SCell index and a low SSB index may be stored first. The above method is an embodiment of the disclosure, and the disclosure may be implemented in a UE in various methods. This may be used to determine a CSI processing unit (CPU) for RS counting and CSI reporting.

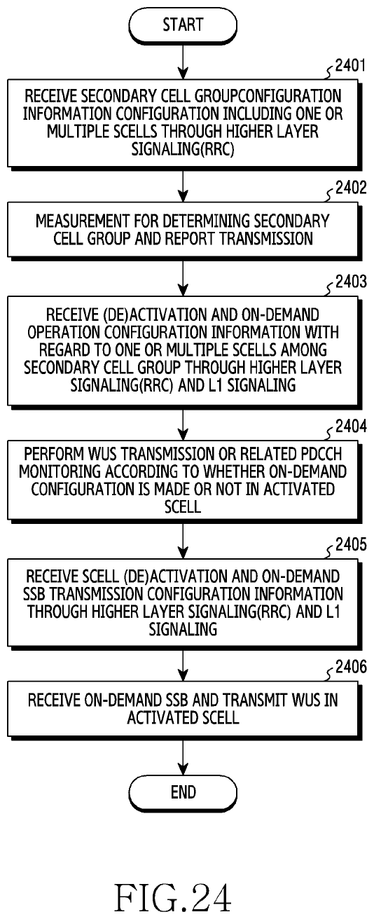

FIG. 24 illustrates a flowchart of a UE to which a wireless communication system's energy saving method according to an embodiment of the disclosure is applied. Based on FIG. 24, the UE's operation during an on-demand operation in an SCell for the gNB's energy saving may be provided.

Referring to FIG. 24, in step 2401, the UE may receive secondary cell group configuration information including information regarding one or more SCells from the gNB through higher layer signaling (e.g., RRC). The UE may receive a secondary cell group configuration from the gNB, and the secondary cell group configuration information may include information regarding at least one candidate SCell applicable to the UE. Candidate SCells may be determined based on the channel state between the UE and SCells or the like.

In step 2402, the UE may perform measurement for determining a secondary cell group and/or transmit a report to the gNB. The UE may perform measurement with regard to cells that transmit SSBs.

In step 2403, the UE may receive SCell activation/deactivation configuration and/or on-demand operation (transmission) configuration information with regard to one or multiple SCells among the secondary cell group through higher layer signaling (e.g., RRC) or L1 signaling. Some SCells may be activated for the gNB's energy saving, and an on-demand SSB may be performed through the activated SCells. The SCell activation/deactivation configuration may be determined based on the traffic state and the gNB's buffer state, the channel state between the UE and candidate SCells, and/or the UE's mobility.

In step 2404, the UE may perform WUS transmission or related PDCCH monitoring according to whether an on-demand configuration is made or not in the activated SCell. The UE may transmit a WUS to request an on-demand SSB. The UE may receive an on-demand SSB in an SCell activated based on a configuration received from the gNB. The UE may perform measurement, based on the received on-demand SSB, or may report the same to the gNB. The UE may perform initial access, based on the received on-demand SSB. The UE may perform no SSB monitoring with regard to SCell(s) for which the on-demand SSB is configured.

In step 2405, the UE may receive SCell activation/deactivation and/or on-demand operation (transmission) configuration information through higher layer signaling (e.g., RRC) and L1 signaling. For the gNB's additional energy saving, some cells' periodic/repeated SSB transmission may be deactivated, and on-demand SSB transmission may be performed.

In step 2406, the UE may perform WUS transmission and/or on-demand SSB reception in activated SCells.

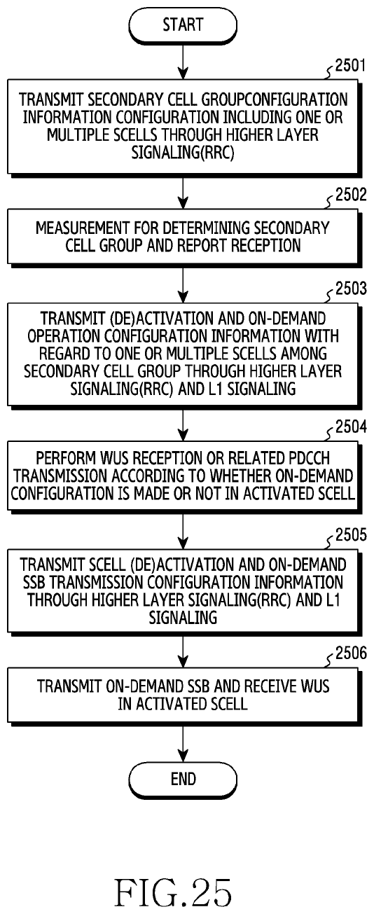

FIG. 25 illustrates a flowchart of a gNB to which a wireless communication system's energy saving method according to an embodiment of the disclosure is applied.

Referring to FIG. 25, in step 2501, the gNB may transmit configuration information regarding a secondary cell group including one or more SCells to the UE through higher layer signaling (e.g., RRC) for the gNB's energy saving.

In step 2502, the gNB may receive a measurement result for determining the secondary cell group from the UE. The gNB may determine the traffic state and the gNB's buffer state, the channel state between the UE and candidate SCells, the UE's mobility, and the like, based on the measurement result.

In step 2503, the gNB may transmit SCell activation/deactivation and on-demand operation configuration information to the UE with regard to one or multiple SCells among the secondary cell group through higher layer signaling (e.g., RRC) and L1 signaling. The gNB may determine SCell activation/(de) activation, based on the traffic state and the gNB's buffer state, the channel state between the UE and candidate SCells, the UE's mobility, and the like. The gNB may transmit an on-demand configuration to the UE, thereby instructing the UE to transmit an on-demand SSB in a specific SCell.

In step 2504, the gNB may perform WUS reception or related PDCCH transmission according to whether an on-demand configuration is made or not in the activated SCell. The gNB may perform WUS monitoring in order to receive on-demand SSB request from the UE.

In step 2505, the gNB may transmit SCell (de) activation and on-demand SSB transmission configuration information through higher layer signaling (e.g., RRC) and L1 signaling. The gNB may pause periodic/repeated SSB for the gNB's additional energy saving, may perform on-demand SSB transmission, and may transmit and indicate activation/deactivation and/or on-demand SSB configuration to the UE in this regard.

In step 2506, the gNB may perform WUS reception and/or on-demand SSB transmission in the activated SCell.

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation.

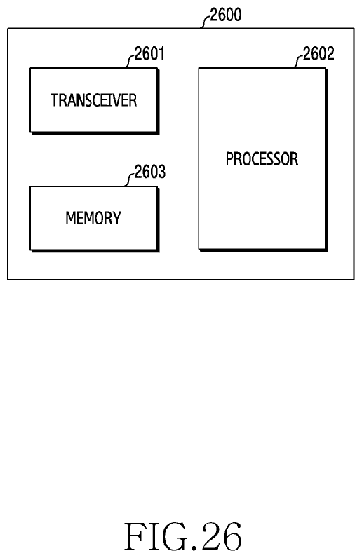

FIG. 26 illustrates a UE according to an embodiment of the disclosure.

Referring to FIG. 26, the UE 2600 may include a transceiver 2601, a controller (for example, processor) 2602, and a storage (for example, memory) 2603. The transceiver 2601, the controller 2602, and the storage 2603 of the UE 2600 may operate according to at least one or a combination of methods corresponding to the above-described embodiments. However, components of the UE 2600 are not limited to the illustrated example. According to another embodiment, the UE 2600 may include a larger or smaller number of components than the above-described components. Furthermore, in a specific case, the transceiver 2601, the controller 2602, and the storage 2603 may be implemented in the form of a single chip.

According to an embodiment, the transceiver 2601 may include a transmitter and a receiver. The transceiver 2601 may transmit/receive signals with the base station. The signals may include control information and data. The transceiver 2601 may include an RF transmitter configured to up-convert and amplify the frequency of transmitted signals, and an RF receiver configured to low-noise-amplify received signals and down-convert the frequency thereof. The transceiver 2601 may receive signals through a radio channel, output the same to the controller 2602, and transmit signals output from the controller 2602 through the radio channel.

The controller 2602 may control a series of processes such that the UE 2600 can operate according to the above-described embodiments of the disclosure. For example, the controller 2602 may perform or control the UE's operations for performing at least one or a combination of the methods according to embodiments of the disclosure. The controller 2602 may include at least one processor. For example, the controller 2602 may include a communication processor (CP) which performs control for communication and an application processor (AP) which controls upper layers (for example, applications).

The storage 2603 may store control information (for example, channel estimation-related information using DMRSs transmitted in a PUSCH included in a signal acquired by the UE 2600) or data, and may have a region for storing data necessary for control of the controller 2602 and data produced during control by the controller 2602.

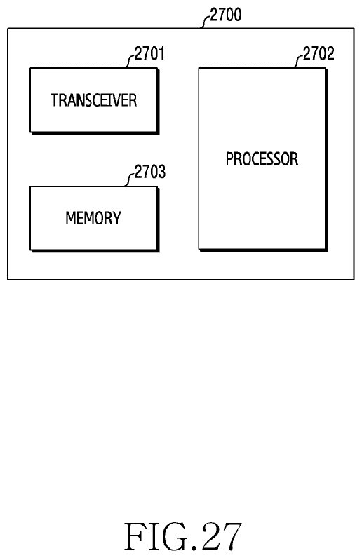

FIG. 27 illustrates a base station according to an embodiment.

Referring to FIG. 27, the UE 2700 may include a transceiver 2701, a controller (for example, processor) 2702, and a storage (for example, memory) 2703. The transceiver 2701, the controller 2702, and the storage 2704 of the base station 2700 may operate according to at least one or a combination of methods corresponding to the above-described embodiments. However, components of the base station 2700 are not limited to the above-described example. According to another embodiment, the base station 2700 may include a larger or smaller number of components than the above-described components. Furthermore, in a specific case, the transceiver 2701, the controller 2702, and the storage 2703 may be implemented in the form of a single chip.

According to an embodiment, the transceiver 2701 may include a transmitter and a receiver. The transceiver 2701 may transmit/receive signals with the UE. The signals may include control information and data. The transceiver 2701 may include an RF transmitter configured to up-convert and amplify the frequency of transmitted signals, and an RF receiver configured to low-noise-amplify received signals and down-convert the frequency thereof. The transceiver 2701 may receive signals through a radio channel, output the same to the controller 2702, and transmit signals output from the controller 2702 through the radio channel.

The controller 2702 may control a series of processes such that the base station 2700 can operate according to the above-described embodiments of the disclosure. For example, the controller 2702 may perform or control the base station's operations for performing at least one or a combination of the methods according to embodiments of the disclosure. The controller 2702 may include at least one processor. For example, the controller 2702 may include a communication processor (CP) which performs control for communication and an application processor (AP) which controls upper layers (for example, applications).

The storage 2703 may store control information (for example, channel estimation-related information generated using DMRSs transmitted in a PUSCH determined by the base station 2700), data, and control information or data received from the UE, and may have a region for storing data necessary for control of the controller 2702 and data produced during control by the controller 2702.

Although the drawings illustrate different examples of a user equipment/base station, various changes and modifications may be made to the drawings. For example, a user equipment/base station may each include any number of components in any appropriate deployments. In general, the drawings do not limit the scope of the disclosure to any specific configurations. Moreover, the drawings illustrate operation environments in which various user equipment/base station features ser forth herein are applicable, but these features may be applied to any other appropriate system.

Although exemplary embodiments of the disclosure have been described, various changes and modifications may be presented to those skilled in the art. The disclosure is intended to cover these changes and modifications falling within ˜ scope of the appended claims. The descriptions of the disclosure should not be construed to suggest that any specific components, steps, or functions are essential element that must be included in the claims. The scope of the patented subject matter is defined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station (BS) on a primary cell, configuration information for an on-demand synchronization signal block (SSB) of a secondary cell;
receiving, from the BS on the primary cell, a downlink signal;
identifying an activation of the on-demand SSB of the secondary cell based on the configuration information and the downlink signal; and
receiving the on-demand SSB of the secondary cell.

2. The method of claim 1, wherein information on a position of the on-demand SSB within an on-demand SSB burst is received via a radio resource control (RRC) signaling.

3. The method of claim 1, wherein the downlink signal includes at least one of a medium access control (MAC) control element (CE) or downlink control information (DCI), and
wherein a deactivation of the on-demand SSB is identified by the MAC CE.

4. The method of claim 1, wherein the activation of the on-demand SSB starts after a pre-defined duration from a reception timing of the downlink signal.

5. The method of claim 1, wherein the activation of the on-demand SSB is identified based on UE capability information related to a total number of the on-demand SSB.

6. A method performed by a base station (BS) in a wireless communication system, the method comprising:
transmitting, to a user equipment (UE) on a primary cell, configuration information for an on-demand synchronization signal block (SSB) of a secondary cell;
transmitting, to the UE on the primary cell, a downlink signal; and
transmitting, to the UE on the secondary cell, the on-demand SSB,
wherein the configuration information and the downlink signal are associated with an activation of the on-demand SSB of the secondary cell.

7. The method of claim 6, wherein information on a position of the on-demand SSB within an on-demand SSB burst is transmitted via a radio resource control (RRC) signaling.

8. The method of claim 6, wherein the downlink signal includes at least one of a medium access control (MAC) control element (CE) or downlink control information (DCI), and
wherein a deactivation of the on-demand SSB is associated with the MAC CE.

9. The method of claim 6, wherein the activation of the on-demand SSB starts after a pre-defined duration from a transmission timing of the downlink signal.

10. The method of claim 6, wherein the activation of the on-demand SSB is associated with UE capability information related to a total number of the on-demand SSB.

11. A user equipment (UE) in a wireless communication system, the UE comprising:
a transceiver; and
a controller coupled with the transceiver and configured to:
receive, from a base station (BS) on a primary cell, configuration information for an on-demand synchronization signal block (SSB) of a secondary cell,
receive, from the BS on the primary cell, a downlink signal,
identify an activation of the on-demand SSB of the secondary cell based on the configuration information and the downlink signal, and
receive the on-demand SSB of the secondary cell.

12. The UE of claim 11, wherein information on a position of the on-demand SSB within an on-demand SSB burst is received via a radio resource control (RRC) signaling.

13. The UE of claim 11, wherein the downlink signal includes at least one of a medium access control (MAC) control element (CE) or downlink control information (DCI), and
wherein a deactivation of the on-demand SSB is identified by the MAC CE.

14. The UE of claim 11, wherein the activation of the on-demand SSB starts after a pre-defined duration from a reception timing of the downlink signal.

15. The UE of claim 11, wherein the activation of the on-demand SSB is identified based on UE capability information related to a total number of the on-demand SSB.

16. A base station (BS) in a wireless communication system, the base station comprising:
a transceiver; and
a controller coupled with the transceiver and configured to:
transmit, to a user equipment (UE) on a primary cell, configuration information for an on-demand synchronization signal block (SSB) of a secondary cell,
transmit, to the UE on the primary cell, a downlink signal,
transmit, to the UE on the secondary cell, the on-demand SSB, and
wherein the configuration information and the downlink signal are associated with an activation of the on-demand SSB of the secondary cell.

17. The BS of claim 16, wherein information on a position of the on-demand SSB within an on-demand SSB burst is transmitted via a radio resource control (RRC) signaling.

18. The BS of claim 16, wherein the downlink signal includes at least one of a medium access control (MAC) control element (CE) or downlink control information (DCI), and
wherein a deactivation of the on-demand SSB is associated with the MAC CE.

19. The BS of claim 16, wherein the activation of the on-demand SSB starts after a pre-defined duration from a transmission timing of the downlink signal.

20. The BS of claim 16, wherein the activation of the on-demand SSB is associated with UE capability information related to a total number of the on-demand SSB.
